(19) United States
(12) Patent Application Publication
(10) Pub. No.: US 2007/0066506 A1
(43) Pub. Date: Mar. 22, 2007

(54) Sulfosuccinates

(76) Inventors: Ansgar Behler, Bottrop (DE); Werner Seipel, Hilden (DE); Almund Folge, Leichilingen (DE)

Correspondence Address: COGNIS CORPORATION;PATENT DEPARTMENT, 300 BROOKSIDE AVENUE, AMBLER, PA, 19002, US

(21) Appl. No.: 10/555,309

(22) PCT Filed: Apr. 30, 2004
(86) PCT No.: PCT/EP04/04590

§ 371 Date: Aug. 16, 2006

(30) Foreign Application Priority Data
May 8, 2003 (DE) 103 20 435.0

(51) Int. Cl. C11D 17/00

(52) U.S. Cl. 510/424; 510/426

(57) ABSTRACT

The invention provides novel sulfosuccinates of the formula 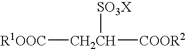
wherein R1 represents a group R³CONR⁴(CH₂)ₙ(OCH₂CH₂)ₘ—, R² represents hydrogen, alkali metal, ammonium, alkyl ammonium or R¹, R³CO represents a linear saturated acyl group having 12 to 18 carbon atoms, R⁴ represents hydrogen or methyl, n is a number of 2 to 4, m is a number of 2 to 10 and X is an alkali metal, ammonium or alkyl ammonium.

### FIELD OF THE INVENTION

The invention relates to the area of anionic surfactants and concerns new sulfosuccinates based on selected ethoxylated fatty acid alkanolamides, a process for their manufacture as well as their use in many application areas.

### STATE OF THE ART

Sulfosuccinates represent anionic surfactants, for applications especially in the area of manual rinsing agents as well as hair shampoos due to their foaming power and their high skin cosmetic compatibility especially as co-surfactant. For their manufacture, in the simplest case, maleic anhydride is subjected to a ring opening with an alcohol and the—according to the stoichiometrically used quantity of alcohol—resulting succinic acid mono- or diester is subsequently sulfited.

During the search for highly productive sulfosuccinates, different investigations have taken place in the past to optimise the structure of the products. Because basically any H-acidic compound is suitable to bring about the ring opening of the maleic anhydride, naturally countless succinic acid full- and half-ester or analogous amides can be thought of, with greatly differing properties. Thus, e.g., special sulfosuccinates are known from the patent U.S. Pat. No. 3,891,682 (Textiliana), which are obtained through condensation of saturated or unsaturated fatty acids with amino ethylene glycol as well as subsequent conversion with MSA and sulfitation. Such products are, for instance, traded under the brand Standapol® SH 100 (disodium PEG-2 oleamido sulfosuccinates). Further sulfosuccinates are known from the EP 0442519 B2 (Benckiser), which are produced through condensation of fatty acids with branched alkanolamines (e.g. monoisopropanolamine MIPA), addition of ethylene oxide as well as conversion with MSA and subsequent sulfitation; a product based on commercial grade coconut oil acid and MIPA4EO is for instance traded under the brand Rewopol® SBZ (disodium PEG4 cocoamido MIPA-sulfosuccinates. However, it is disadvantageous that, though the products of the prior art show a satisfactory foaming behaviour, the height foam and the foam stability, especially in presence of hard water and, if applicable, in presence of fat, remains to be desired.

The task of the present invention has consequently been to make available new sulfosuccinates through selection and combination of the different structure features, which are superior to those of the prior art and distinguish themselves for at least comparable skin cosmetic compatibility by an improved foaming power, especially with regard to the foam stability in the presence of water hardness and, should the occasion arise, grease load.

### BRIEF SUMMARY OF THE INVENTION

The invention relates to novel sulfosuccinates of formula (I), wherein R¹ represents a group R³CONR⁴(CH₂)ₙ(OCH₂CH₂)ₘ—, R² represents hydrogen, an alkali metal, ammonium, alkyl ammonium or R¹, R³CO represents a linear, saturated acyl radical having 12-18 carbon atoms, R⁴ represents hydrogen or methyl, n represents the numbers 2 to 4, m represents the numbers 2 to 10 and X represents an alkali metal, ammonium or alkyl ammonium.

### DETAILED DESCRIPTION OF THE INVENTION

Subject matter of the invention is new sulfosuccinates of the formula (I), 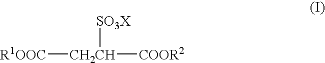
wherein, R¹ represents a group R³CONR⁴(CH₂)ₙ(OCH₂CH₂)ₘ—, R² represents hydrogen, an alkali metal, ammonium, alkyl ammonium or R¹, R³CO represents a linear, saturated acyl radical having 12 tol8 carbon atoms, R⁴ represents hydrogen or methyl, n represents the numbers 2 to 4, m represents the numbers 2 to 10 and X represents an alkali metal, ammonium or alkyl ammonium.

Preferably in formula (I)
R² represents an alkali metal,
R³CO represents a linear, saturated acyl radical having 12 tol4 carbon atoms,
R⁴ represents hydrogen,
n represents 2 or 3 and
m represents a number between 3 and 5.

Especially preferred are sulfosuccinates, which, sum up the preferred individual features, in which according to formula (I), R² represents an alkali metal, R³CO represents a linear, saturated acyl radical having 12 to 14 carbon atoms, R⁴ represents hydrogen, n represents 2 or 3, m represents a number between 2 to 6 and X represents an alkali metal.

Surprisingly, it was found that sulfosuccinates of formula (I) fulfill the requirements to a large extent through a specific selection and combination of different structure parameters. Especially, they distinguish themselves both in the RBC- as well as in the HET-CAM-test by a high skin cosmetic compatibility. Furthermore, they show on direct comparison with the products of the prior technology, a higher foaming behaviour and a higher foam stability, especially in the presence of hardness components and grease load.

A further subject matter of the present invention concerns a process for the manufacture of sulfosuccinates according to formula (I), comprising
(a) condensing fatty acids with 12 to 18 carbon atoms by known method with linear C₂-C₄ alkanolamines,
(b) adding to the resulting fatty acid alkanolamides, on an average, 1 to 10 mol ethylene oxide by known method,
(c) reacting the fatty acid alkanolamidepoly glycol ether thus obtained with maleic anhydride (MSA) by known method, and finally
(d) adding to the succinic acid ester thus obtained hydrogen sulfite by known method.

Amidation and Ethoxylation

The manufacture of fatty acid alkanolamidepolyalkylene glycol ethers occurs as a rule by addition of alkylene oxides to fatty acid alkanolamides in the presence of alkaline catalysts. Preferably, the reaction is carried out in the presence of reducing agents and the reaction products obtained in this way are afterwards subjected to a steam treatment under alkaline conditions, in order to ensure a superior colour quality. Preferably, alkanolamids based on saturated fatty acids or fatty acid mixtures can be used as reactants, which have 12 to 18, but particularly 12 to 14 carbon atoms. Typical examples are condensation products of caproic acid, caprylic acid, capric acid, lauric acid, myristic acid, palmitic acid, stearic acid, isostearic acid, 12-hydroxystearic acid, arachidonic acid, behenic acid, as well as their technical-grade mixtures, especially if necessary hydrogenated coconut acid, palm-kernel acid, palm acid and tallow fatty acid with monoethanolamine (MEA), diethanolamine (DEA), monopropanolamine (MPA) and dipropanolamine (DPA) as well as their mixtures. Preferably, condensation products of coconut or tallow fatty acids with monoethanolamine are used.

Besides the alkali hydroxides and carbonates, above all also alcoholates, especially sodium methylate, sodium ethylate or potassium-tert.butylate as well as tertiary amines are suitable as alkaline catalysts for the amidation and ethoxylation. Typically, the amount required of the alkaline catalysts amounts to 0.1 to 5, preferably 0.5 to 2% by weight with reference to the used material. Boron hydrides, especially sodium borohydride, as well as hypophosphorous acid or its alkali salts, for instance, are taken into consideration as reducing agent. The amount required amounts to as a rule from 0.1 to 2.5, preferably 0.2 to 1% by weight, with reference to the used material.

The alkoxylation of the fatty acid alkanolamides can be carried out by known method. As a rule, one uses agitated autoclaves, which are cleansed from adhering traces of water as well as oxygen through alternate heating, evacuating and nitrogen feeding. The amides are placed together with the catalyst and the reducing agent and heated under pressure, for which a temperature of 80 to 150° C. is usual and 110 to 140° C. preferred.

The pressure lies in the range of 1 to 10 and preferably 3 to 6 bar. The alkylene oxide is pressed on in portions, for which it is recommended to allow additional one to two hours post-reaction time after the ending of the feeding, at which point in time the temperature can be reduced gradually. After the alkoxylation, the reaction products typically have a Gardner color standard number of 3 to 4.

After cooling and release of the reaction mixture, the raw reaction products are usually subjected to a steam treatment, for which it is decisive that beforehand an alkaline pH-value, preferably pH=9 to 12, is set. This happens, for instance, through addition of an aqueous alkali base. Finally, steam is lead through the reaction mixture at 100 to 120° C. and with continuous stirring such that about 20 to 25% by weight of the used steam quantity yields as condensate. This corresponds typically to a treatment over a period of 30 min. Thereafter, the alkoxylation product is dried, which typically now shows a Gardner color standard number of below 2 and a dioxane content of less than 1 ppm.

Ring Opening and Sulfitation

The manufacture of the succinic acid ester can take place by known method, in which one uses the fatty acid alkanolamidepoly glycol ether and the MSA as a rule in the molar ratio of 1:1 to 1:1.5 and preferably 1:1.1 to 1:1.3. The conversion occurs typically at 60 to 90° C. under addition of the MSA in portions and in the absence of solvents. Sodium carbonate, for instance, is suitable as catalyst. The final addition of the sulfite to the double bond occurs usually in aqueous solution using an alkali or ammonium sulfite, in which the molar quantities used of double bond component and sulfite lie in the range of 1:0.9 to 1:1.1 and preferably amounts to about 1:1. The sulfitation takes place usually at temperatures in the range of 60 to 80° C. and delivers the sulfosuccinates as diluted aqueous pastes with salt contents of typically less than 2% by weight.

### INDUSTRIAL APPLICATION

The new sulfosuccinates, according to the invention, possess a special skin compatibility and an improved foaming behaviour, especially with regard to the foam stability in the presence of hardness components and grease load. Therefore, the further subject matters of the invention concern their use both for the manufacture of cosmetics and/or pharmaceutical preparations, especially of hair shampoos, as well as washing, rinsing, cleaning and softening compositions, especially manual dishwashing formulations, in which they can be present in quantities of 1 to 30, preferably 3 to 20 and particularly 5 to 15% by weight with reference to the end preparations.

Surfactant Mixture

In an especially preferred embodiment of the present invention, the sulfosuccinates are used together with amphoteric surfactants of alkylamidobetaines types and/or non-ionic surfactants of the type alkyloligoglycosides, since such preparations in the weight ratio 10:90 to 90:10, preferably 25:75 to 75:25 and particularly 40:60 to 60:40, show synergies both in the foaming behaviour as well as in the skin compatibility.

Alkylamidobetaines

Alkylamidobetaines, are carboxyalkylation products of amidoamines, of the formula (II), 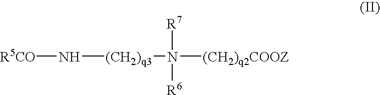
in which, R⁵CO represents an aliphatic acyl radical with 6 to 22 carbon atoms and 0 or 1 to 3 double bonds, R⁶ represents hydrogen or alkyl radical with 1 to 4 carbon atoms, R⁷ represents alkyl radical with 1 to 4 carbon atoms, q² represents numbers from 1 to 6, q³ represents numbers between 1 to 3 and Z again represents an alkali and/or alkaline earth metal or ammonium. Typical examples are conversion products of fatty acids with 6 to 22 carbon atoms, namely caproic acid, caprylic acid, capric acid, lauric acid, myristic acid, palmitic acid, palmolein acid, stearic acid, isostearic acid, oleic acid, elaidic acid, petroselic acid, linolic acid, linolenic acid, elaeostearic acid, arachic acid, gadolein acid, behenic acid and erucic acid as well as their technical-grade mixtures, with N,N-dimethylaminoethylamine, N,N-dimethylaminopropylamine, N,N-diethylaminoethylamine and N,N-diethyl-aminopropylamine, which are condensed with sodium chloroacetate. The use of a condensation product of C_{8/18}-coconut oil acid-N,N-dimethylaminopropylamide with sodium chloroacetate is preferred.

Alkylolicoglycosides

Alkyloligoglycosides represent known non-ionic surfactants, which have the formula (III),
R⁸O-[G]ₚ (III)
in which R⁸ represents an alkyl radical with 4 to 22 carbon atoms, G represents a residue sugar with 5 or 6 carbon atoms and p represents numbers from 1 to 10. They can be obtained according to the relevant method of the preparative organic chemistry. The alkyloligoglycosides can be derived from aldoses or ketoses with 5 or 6 carbon atoms, preferably from the glucose. The preferred alkyloligoglycosides are consequently alkyloligoglucosides. The index number p in the general formula (I) indicates the oligomerisation degree (DP), i.e. the distribution of mono- and oligoglycosides and represents a number between 1 and 10. While p in a given compound must always be a whole number and above all the value p=1 to 6 can be assumed here, the value p for a specific alkyloligoglycoside is an analytically determined calculated number, which represents mostly a fractional number. Preferably, alkyloligoglycosides with a mean oligomerisation degree p of 1.1 to 3.0 are used. From application point of view, such alkyloligoglycosides are preferred, whose oligomerisation grade is less than 1.7 and particularly lies between 1.2 and 1.4.

The alkyl radical R⁸ can be derived from primary alcohols with 4 to 11, preferably 8 to 10, carbon atoms. Typical examples are butanol, hexyl alcohol, capryl alcohol, decyl alcohol and undecyl alcohol as well as their technical-grade mixtures, for instance, obtained by the hydration of commercial fatty acid methyl esters or in the course of the hydration of aldehydes from the Roelen oxo-synthesis. Alkyloligoglucosides of the chain length C₈-C₁₀ (DP=1 to 3), which precipitate preliminarily during the distillate separation of commercial C₈-C₁₈ coconut oil alcohol and can be contaminated with a proportion of less than 6% by weight C₁₂ alcohol as well as alkyloligoglucosides based on commercial C9/11-oxoalcohol (DP=I to 3) are preferred. The alkyl radical R⁸ can be further derived from primary alcohols with 12 to 22, preferably 12 to 14, carbon atoms. Typical examples are lauryl alcohol myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol as well as there technical-grade mixtures, which can be obtained as described above. Alkyloligoglucosides based on hydrogenated C_{12/14}-coconut alcohol with a DP of 1 to 3 are preferred.

Cosmetic and/or Pharmaceutical Preparations

The sufosuccinates or surfactant mixtures according to the invention can serve for the manufacture of cosmetic and/or pharmaceutical preparations, like, for instance, hair shampoos, hair lotions, foam baths, shower baths, creams, gels, lotions, alcoholic and aqueous/alcoholic solutions, emulsions, waxy/fatty substances, foundation preparations and such others. Especially, however on this basis, mild and foam-rich hair shampoos are manufactured. These preparations can further contain, as additional auxiliaries and additives, mild co-surfactants, oil components, emulsifiers, pearlescent waxes, consistency agents, thickeners, refatting agents, stabilizers, polymers, silicon compounds, fats, waxes, lecithin, phospholipids, UV-sunscreens, biogenic active agents, antioxidants, deodorants, antiperspirants, anti-dandruff agents, film formers, swelling agents, insect repellents, self-tanners, tyrosine inhibitors (depigmentation agent), hydrotropes, solubilizers, preservatives, perfume oils, coloring agents and the like.

Co-Surfactants

Anionic, non-ionic, cationic and/or amphoteric or zwitterionic surfactants may be used as surface-active materials, whose proportion on an average generally amounts to approximately 1 to 70, preferably 5 to 50 and particularly 10 to 30% by weight. Typical examples for anionic surfactants are soaps, alkylbenzenesulfonates, alkylsulfonates, olefinsulfonates, alkyl ether sulfonates, glycerine ether sulfonates, a-methyl ester sulfonates, alkyl sulfonic acids, alkyl sulfates, alkyl ether sulfates, glycerine ethersuphates, fatty acid ether sulfates, hydroxy mixed ether sulfates, monoglyceride(ether) sulfates, fatty acid amide(ether) sulfates, mono- and di-alkylsulfosuccinates, mono- and di-alkylsulfosuccinamates, sulfotriglycerides, amide soaps, ether carboxylic acids and their salts, fatty acid isethionates, fatty acid sarcosinates, fatty acid taurides, N-acyl amino acids, e.g. acyl lactylates, acyl tartrates, acyl glutamates and acyl aspartates, alkyl oligoglucoside sulfates, protein fatty acid condensates (especially plant products based on wheat) and alkyl(ether)phosphates. As long as the anionic surfactants contain poly glycol ether chains, these can exhibit a conventional, preferably however a limited, homologous distribution.

Typical examples of non-ionic surfactants are fatty alcohol poly glycol ethers, alkyl phenol polyglycol ethers, fatty acid polyglycol esters, fatty acid amide polyglycol ethers, fatty amine polyglycol ethers, alkoxylated triglycerides, mixed ether or mixed formals, glucoron acid derivatives, fatty acid-N-alkyl glucamides, protein hydrolysate (especially plant products based on wheat), polyol fatty acid esters, sugar esters, sorbitan esters, polysorbates and amine oxides. As long as the non-ionic surfactants contain polyglycol ether chains, these can exhibit a conventional, preferably however a limited, homologous distribution.

Typical examples for cationic surfactants are quaternary ammonium compounds, e.g., the dimethyldistearyl ammonium chloride, and ester quats, especially quaternary fatty acid trialkanolamine ester salts. Typical examples of amphoteric or zwitterionic surfactants are alkyl betaines, aminopropionates, aminoglycinates, imidazolinium betaines and sulfobetaines. The mentioned surfactants deal exclusively with known compounds.

Oil Components

As oil components, we have, by way of example, guerbet alcohols based on fatty alcohols with 6 to 18, preferably 8 to 10 carbon atoms, esters of linear C₆-C₂₂ fatty acids with linear or branched C₆-C₂₂ fatty alcohols or esters of branched C₆-C₁₃ carboxylic acids with linear or branched C₆-C₂₂ fatty alcohols, e.g. myristyl myristate, myristyl palmitate, myristylstearate, myristyl isostearate, myristyloleate, myristylbehenate, myristylerucate, cetylmyristate, cetylpalmitate, cetylstearate, cetyl isostearate, cetyloleate, cetylbehenate, cetylerucate, stearylmyristate, stearylpalmitate, stearylstearate, stearylisostearate, stearyloleate, stearylbehenate, stearylerucate, isostearyl myristate, isostearylpalmitate, isostearylstearate, isostearylisostearate, isostearyloleate, isostearylbehenate, isostearyloleate, oleylmyristate, oleylpalmitate, oleylstearate, oleylisostearate, oleyloleate, oleylbehenate, oleylerucate, behenylmyristate, behenylpalmitate, behenylstearate, behenylisostearate, behenyloleate, behenyl behenate, behenylerucate, erucylmyristate, erucylpalmitate, erucylstearate, erucylisostearate, erucyloleate, erucylbehenate and erucylerucate.

Besides, ester of linear C₆-C₂₂ fatty acids with branched alcohols, especially 2-ethylhexanol, ester of C₁₈-C₃₈ alkyl hydroxycarboxylic acids with linear or branched C₆-C₂₂ fatty alcohols, especially dioctyl malates, esters of linear and/or branched fatty acids with polyvalent alcohols (e.g. propylene glycol, dimer diol or trimer triol) and/or guerbet alcohols, triglycerides based on C₆-C₁₀ fatty acids, liquid mono-/di-/tri-glyceride mixtures based on C₆-C₁₈ fatty acids, ester of C₆-C₂₂ fatty alcohols and/or guerbet alcohols with aromatic carboxylic acids, especially benzoic acids, ester of C₂-C₁₂ dicarboxylic acids with linear or branched alcohols with 1 to 22 carbon atoms or polyols with 2 to 10 carbon atoms and 2 to 6 hydroxyl groups, plant oils, branched primary alcohols, substituted cyclohexanes, linear or branched C₆-C₂₂ fatty alcohol carbonates, e.g. dicaprylyl carbonates (Centiol® CC), guerbet carbonates based on fatty alcohols with 6 to 18, preferably 8 to 10 C atoms, esters of the benzoic acid with linear and/or branched C₆-C₂₂ fatty alcohols (e.g. Finsolv® TN), linear or branched chain symmetric or asymmetric dialkyl ether with 6 to 22 carbon atoms per alkyl group, e.g. dicaprylyl ether (Cetiol® OE), ring opening products of epoxidized fatty acid esters with polyols, silicon oils (cyclomethicones, silicon methicon types etc.) and/or aliphatic or naphthenic hydrocarbons, e.g. squalane, squalene or dialkyl cyclohexanes are suitable.

Emulsifiers

Non-ionic surfactants from one of the following groups are considered as emulsifiers:
Addition products of 2 to 30 mol ethylene oxide and/or 0 to 5 mol propylene oxide to linear fatty alcohols with 8 to 22 C atoms, to fatty acids with 12 to 22 C atoms, to alkyl phenols with 8 to 15 C atoms in the alkyl group as well as alkylamines with 8 to 22 carbon atoms in the alkyl group;
Addition products of 1 to 15 mol ethylene oxide with castor oil and/or hydrogenated castor oil;
Addition products of 15 to 60 mol ethylene oxide with castor oil and/or hydrogenated castor oil;
Partial esters of glycerine and/or sorbitan with saturated or unsaturated, linear or branched fatty acids with 12 to 22 carbon atoms and/ or hydroxyl carboxylic acids with 3 to 18 carbon atoms as well as their adducts with 1 to 30 mol ethylene oxide;
Partial esters of polyglycerol (average condensation degree 2 to 8), polyethylene glycol (molecular weight 400 to 5000), trimethylolpropane, pentaerythritol, sugar alcohols (e.g. sorbitol), alkylglucosides (e.g. methylglucoside, butylglucoside, laurylglucoside) as well as polyglucosides (e.g. cellulose) with saturated and/or unsaturated, linear or branched chain fatty acids with 12 to 22 carbon atoms and/or hydroxycarboxylic acids with 3 to 18 carbon atoms as well as their adducts with I to 30 mol ethylene oxide;
Mixed esters of penataerythritol, fatty acids, citric acid and fatty alcohol and/or mixed esters of fatty acids with 6 to 22 carbon atoms, methyl glucose and polyols, preferably glycerol or polyglycerol.
Mono-, di- and tri-alkylphosphates as well as mono-, di- and/or tri-PEG-alkylphosphates and their salts;
Wool wax alcohols;
Polysiloxane-polyalkyl-polyether copolymers or corresponding derivatives;
Block copolymers e.g. polyethylene glycol-30 dipolyhydroxystearates;
Polymer emulsifiers, e.g. pemulene types a (TR-1, TR-2) of Goodrich;
Polyalkylene glycols as well as
Glycerol carbonate.

Ethylene Oxide Addition Products The addition products of ethylene oxide and/or of propylene oxide with fatty alcohols, fatty acids, alkyl phenols or with castor oil represent known products obtainable commercially. Besides, it is a question of homologous mixture, whose mean alkoxylation degree corresponds to the proportion of the amount of substance of ethylene oxide and/or propylene oxide and reactant, with which the addition reaction is carried out. C1_{2,18} fatty acid mono- and diesters of addition products of ethylene oxide to glycerol are known as refatting agent for cosmetic preparations.

Partial Glycerides

Typical examples for suitable partial glycerides are glycerol monohydroxy stearate, glycerol dihydroxystearate, glycerol monosestearate, glycerol diisostearate, glycerol monooleate, glycerol dioleate, glycerol diricinoleate, glycerol monoricinoleate, glycerol monolinoleate, glycerol dilinoleate, glycerol monolinolenate, glycerol dilenolenate, glycerol monoerucate, glycerol dierucate, glycerol monotartrate, glycerol ditartrate, glycerol monocitrate, glycerol dicitrate, glycerol monomalate, glycerol dimalate as well as their technical-grade mixtures, which after the manufacturing process still contain small quantities of triglycerides. Likewise, addition products of 1 to 30, preferably 5 to 10, mol ethylene oxide with the mentioned partial glycerides are suitable.

Sorbitan Esters

Examples of sorbitan esters are: sorbitan monoisostearate, sorbitan sesquiisostearate, sorbitan diisostearate, sorbitan triisostearate, sorbitan monooleate, sorbitan sesquioleate, sorbitan dioleate, sorbitan trioleate, sorbitan monoerucate, sorbitan sesquierucate, sorbitan dierucate, sorbitan trierucate, sorbitan monoricinoleate, sorbitan sesquiricinoleate, sorbitan diricinoleate, sorbitan triricinoleate, sorbitan monohydroxystearate, sorbitan sesquihydroxystearate, sorbitan dihydroxystearate, sorbitan trihydroxystearate, sorbitan monotartrate, sorbitan sesquitartrate, sorbitan ditartrate, sorbitan tritartrate, sorbitan monocitrate, sorbitan sesquicitrate, sorbitan dicitrate, sorbitan tricitrate, sorbitan monomaleate, sorbitan sesquimaleate, sorbitan dimaleate, sorbitan trimaleate as well as their technical-grade mixtures. Likewise, addition products of 1 to 30, preferably 5 to 10, mol ethylene oxide with the above mentioned sorbitan esters are suitable.

Polyalycerol Ester

Typical examples of polyglycerol esters are polyglyceryl-2 dipolyhydroxystearate (Dehymuls® PGPH), polyglyceryl-3-diisostearates (Lameform® TGI), polyglyceryl-4 isostearates (Isolan® GI 34), polyglyceryl-3 oleates, diisostearoyl polyglyceryl-3-diisostearates (Isolan® PDI), polyglyceryl-3-methylglucose distearates (Tego Care® 450), polyglyceryl-3 beeswax (Cera Bellina®), polyglyceryl-4 caprates (Polyglycerol Caprate T2010/90), polyglyceryl-3 cetyl ether (Chimexane® NL), polyglyceryl-3 distearates (Cremophor® GS 32) and polyglyceryl polyricinoleates (Admul® WOL 1403) polyglyceryl dimerate isostearates as well as their mixtures. Examples for further suitable polyesters are the mon-, di- and triesters of trimethylol propane, if necessary, reacted with 1 to 30 mol ethylene oxide or pentaerythritol with lauric acid, coconut acid, tallow fatty acid, palmitic acid, stearic acid, oleic acid, behenic acid and the like.

Anionic Emulsifiers

Typical anionic emulsifiers are aliphatic fatty acids with 12 to 22 carbon atoms, e.g. palmitic acid, stearic acid or behenic acid, as well as dicarboxylic acids with 8 to 22 carbon atoms, e.g. azelaic acid or sebacic acid.

Fats and Waxes

Typical examples for fats are glycerides, i.e. solid or liquid plant or animal products, which essentially consist of mixed glycerol esters of higher fatty acids; as waxes can be used, among others, natural waxes, like candelilla wax, carnauba wax, japan wax, esparto grass wax, cork wax, guaruma wax, rice oil wax, sugar-cane wax, ouricury wax, montan wax, beeswax, shellac wax, spermaceti wax, lanolin (wool wax), rump wax, ceresin, ozocerite (earth wax), petrolatum, paraffin wax, micro waxes; chemically modified waxes (hard waxes), e.g. montan ester waxes, sasol waxes, hydrogenated jojoba waxes as well as well as synthetic waxes, e.g. polyalkylene waxes and polyethylene glycol waxes. Besides the fats, also fatty substances like lecithins and phospholipides can be used as additional materials. Under the designation “lecithins”, the skilled person understands those glycerol phospholipides, which are formed from fatty acids, glycerol, phosphoric acid and choline by esterification. Lecithins are therefore also known frequently as phosphatidyl cholines (PC) in the professional field. As examples for natural lecithins, the cephalins may be mentioned, which are also designated as phosphatidic acids and represent derivatives of the 1,2-diacyl-sn-glycerine-3-phosphoric acids. In comparison, one understands under phospholipides usually mono-, and preferably, -diesters of phosphoric acid with glycerine (glycerine phosphates), which are generally reckoned as fats. Besides that, also sphingosines or sphingolipids can be used.

Pearlescent Waxes

Example of pearlescent waxes are: alkylene glycol esters, especially ethylene glycol distearate; fatty acid alkanolamides, specially coconut acid diethanolamide; partial glycerides, specially stearic acid monoglyceride; esters of polyvalent, if necessary, hydroxyl-substituted carboxylic acids with fatty alcohols with 6 to 22 carbon atoms, specially long-chain esters of tartaric acid; fatty materials, e.g. fatty alcohols, fatty ketones, fatty aldehydes, fatty ether and fatty carbonates, which have in total, a minimum 24 carbon atoms, specially laurone and distearylether; fatty acids like stearic acid, hydroxystearic acid or behenic acid, ring opening products of olefin epoxides with 12 to 22 carbon atoms with fatty alcohols with 12 to 22 carbon atoms and/or polyols with 2 to 15 carbon atoms and 2 to 10 hydroxyl groups as well as their mixtures.

Consistency Agents and Thickeners

Primarily, fatty alcohols or hydroxy fatty alcohols with 12 to 22 and preferably 16 to 18 carbon atoms and partial glycerides of fatty acids or hydroxy fatty acids are used as consistency agents. A combination of these materials with alkyl oligoglucosides and/or fatty acid-N-methylglucamides of the same chain length and/or polyglycerol poly-12-hydroxystearates are preferred. Suitable thickeners are, for instance, aerosol types (hydrophilic silicic acid), polysaccharides, especially xanthan gum, guar-guar, agar-agar, alginates and tyloses, carboxymethyl cellulose and hydroxyethyl- and hydroxypropyl cellulose, further high molecular weight polyethyleneglycol mono- and diesters of fatty acids, polyacrylates, (e.g. Carbopole® and permulen types of Goodrich; Synthalene® of Sigma; keltrol types of Kelco; sepigel types of Seppic; salcare types of Allied Colloids), polyacrylamides, polyvinylalcohol and polyvinylpyrrolidone. Bentonites, e.g. Bentone® Gel VS-5PC (Rheox) have also proved especially effective, and a mixture of cyclopentasiloxane, disteardimonium hectorite and propylene carbonate. Further, surfactants, e.g. ethyloxylated fatty acid glycerides, esters of fatty acids with polyols e.g. pentaerythritol or trimethylolpropane, fatty alcohol ethoxylates with limited homologous distribution or alkyl oligoglucosides as well as electrolytes like table salt and ammonium chloride can be used.

Refatting Agent

Substances e.g. lanolin and lecithin as well as polyethoxylated or acylated lanolin- and lecithin derivatives, polyol fatty acid esters, monoglycerides and fatty acid alkanolamides can be used as refatting agent, in which the latter ones serve at the same time as a foam stabiliser.

Stabilisers

Metal salts of fatty acids e.g. magnesium-, aluminum- and/or zinc stearate or -ricinoleate can be used as stabilisers.

Polymers

Suitable cationic polymers are for instance cationic cellulose derivatives, e.g. a quatemized hydroxyethylcellulose, which can be obtained under the brand Polymer JR 400® of Amerchol, cationic starch, copolymers of diallylammonium salts and acrylamides, quaternized vinylpyrrolidone/ vinylimidazol polymers, e.g. Luviquato® (BASF), condensation products of polyglycols and amines, quaternized collagen polypeptides, e.g. lauryldimonium hydroxypropyl hydrolysed collagen (Lamequat®L/Grünau), quaternized wheat polypetides, polyethyleneimine, cationic silicon polymers, e.g. amodimethicones, copolymers of the adipic acid and dimethyl aminohydroxypropyidiethylenetriamine (Cartertine®/Sandoz), copolymers of the acrylic acid with dimethyl diallyl ammonium chloride (Merquat® 550/Chemviron), polyaminopolyamides, e.g. described in the FR 2252840 A as well as their interlinked water-soluble polymers, cationic chitin derivatives e.g. quaternized chitosan, if necessary, distributed as microcrystalline, condensation products from dihalogen alkyls, e.g. dibromobutane with bis-dialkylamines, e.g. bis-dimethylamino-1,3-propane, cationic guar-gum, e.g. Jaguar® CBS, Jaguar® C-17, Jaguar® C-16 of the company Celanese, quaternized ammonium salt polymers, e.g. Mirapol® A-15, Mirapol® AD-1, Mirapol® AZ-1 of the company Miranol.

Ionic, zwitterionic, amphoteric and non-ionic polymers can be used, for instance, vinylacetate/crotonic acid copolymers, vinylpyrrolidone/vinylacetate copolymers, vinylacetate/butylmaleate/isobornylacrylate copolymers, methylvinylether/maleic anhydride copolymers and their esters, unlinked and interlinked with polyols, polyacrylic acids, acrylamidopropyltrimethylammonium chloride/acrylate copolymers, octylacrylamide/methylmethacrylate/tert.butylaminoethylmethacrylate/2-hydroxypropylmethacrylate copolymers, polyvinylpyrrolidone, vinylpyrrolidone/vinylacetate copolymers, vinylpyrrolidone/dimethylaminoethylmethacrylate/vinylcaprolactam terpolymers as well as, if necessary, derived cellulose ethers and silicones.

Silicon Compounds

Suitable silicon compounds are, for instance, dimethylpolysiloxanes, methylphenylpolysiloxanes, cyclic silicones as well as amino-, fatty acid-, alcohol-, polyether-, epoxy-, fluoro-, glycoside-, and/or alkyl-modified silicon compounds, which can be present both in liquid as well as resin form at room temperature. Further suitable are simethicons, which are mixtures of dimethicons with an average chain length of 200 to 300 dimethylsiloxane units and hydrated silicates.

UV-Sunscreen Filters

Under UV-sunscreen filters, one understands, for instance, organic substances (sunscreen filters) existing in liquid or crystalline form at room temperature, which can absorb ultraviolet rays and give out the absorbed energy again in the form of long wave-length radiation, e.g. heat. UVB filters can be oil-soluble or water-soluble. The following can be used, by way of example, as oil-soluble:
3-benzylidene camphor or 3-benzylidene norcamphor and its derivatives, e.g. 3-(4-methylbenzylidene) camphor;
4-aminobenzoic acid derivatives, preferably 4-(dimethylaminoy benzoic acid-2-ethylhexylester, 4-(dimethylamino)benzoic acid-2-octyl ester and 4-(dimethylamino)benzoic-acid amyl ester;
Esters of cinnamic acid, preferably 4-methoxycinnamic acid-2-ethylhexyl ester, 4-methoxycinnamic acid propyl ester, 4-methoxycinnamic acid isoamyl ester, 2-cyano-3,3-phenylcinnamic acid-2-ethylhexyl ester (octocrylenes);
Esters of the salicylic acid, preferably salicylic acid-2-ethylhexyl ester, salicylic acid-4-isopropylbenzyl ester, salicylic acid homomenthyl ester;
Derivatives of the benzophenones, preferably 2-hydroxy-4-methoxybenzophenone, 2-hydroxy-4-methoxy-4′-methylbenzophenone, 2,2′-dihydroxy-4-methoxybenzophenone;
Esters of the benzalmalonic acid, preferably 4-methoxybenzalmalonic-acid-di-2-ethylhexyl ester;
Triazine derivatives, e.g. 2,4,6-trianilino-(p-carbo-2′-ethyl-1′-hexyloxy)-1,3,5-triazine and octyl triazone or dioctyl butamido triazones (Uvasorb® HEB);
Propane-1,3-diones, e.g. 1-(4-ter.butylphenyl)-3-(4′methoxyphenyl) propane-1,3-dione;
Ketotricyclo(5,2,1,0)decane derivatives.

The following can be used as water-soluble substances:
2-phenylbenzimidazol-5-sulfonic acid and its alkali-, alkaline earth, ammonium, alkylammonium-, alkanolammonium- and glucammonium salts;
Sulfonic acid derivatives of benzophenones, preferably 2-hydroxyl-4-methoxybenzophenon-5-sulfonic acid and their salts

Sulfonic acid derivatives of 3-benzylidene camphor, e.g. 4-(2-oxo-3-bornylidenemethyl)benzylsulfonic acid and 2-methyl-5-(2-oxo-3-bornylidene)sulfonic acid and their salts.

Especially derivatives of the benzoylmethane can be used as typical UV-A filters, e.g. 1-(4′-tert.butylphenyl)-3-(4′-methoxyphenyl)propane-1,3-dione, 4-tert.-butyl-4′-methoxydibenzoylmethane (Parsol® 1789), 1-phenyl-3-(4′-isopropylphenyl)-propane-1,3-dione as well as enamine compounds.

The UV-A and UV-B filters can obviously be used in mixtures also. Especially favorable combinations consist of the derivatives of the benzoylmethanes, e.g. 4-tert.-butyl-4′-methoxydibenzoylmethane (Parsol® 1789) and 2-cyano-3,3-phenylcinnamicacid-2-ethyl-hexyl ester (octocrylenes) in combination with esters of the cinnamic acid, preferably 4-methoxycinnamic acid-2-ethylhexyl ester and/or 4-methoxycinnamic acid propyl ester and/or 4-methoxycinnamic acid isoamyl ester. Such combinations with water-soluble filters e.g. 2-phenylbenzimidazol-5-sulfonic acid and its alkali-, alkaline earth, ammonium, alkylammonium-, alkanolammonium- and glucammonium salts combined are advantageous.

Besides the soluble materials mentioned, insoluble sunscreen pigments, namely finely dispersed metal oxides or salts, also can be used for this purpose. Examples for suitable metal oxides are especially zinc oxide and titanium dioxide and besides that oxides of iron, zirconium, silicon, manganese, aluminum and cerium as well as their mixtures. Silicates (talc), barium sulfate or zinc stearate can be used as salts. The oxides and salts are used in the form of pigments for skin-care and skin-protection emulsions and decorative cosmetics. For this, the particles should have an average diameter less than 100 nm, preferably between 5 and 50 and particularly between 15 and 30 nm. They can have a spherical shape, but however such particles, which have an ellipsoid shape or shapes deviating from spherical in other ways, can also be used. The pigments can also be present as surface-treated, i.e. hydrophilic or hydrophobic. Typical examples are coated titanium oxides, e.g. titanium dioxide T 805 (Degussa) or Eusolex® T2000 (Merck). Above all, silicones can be used as hydrophobic coating agent for this and specially trialkoxyoctylsilanes or simethicones for this. So-called micro- or nano-pigments are used in sunscreen agents. Preferably, micronised zinc oxide is used.

Biogenic Active Agents and Antioxidants

Under biogenic agents, one understands, for instance, tocopherol, tocopheryl acetate, tocopherol palmitate, ascorbic acid, (desoxy)ribonucleic acid and their fragmentation products, β-glucane, retinol, bisabolol, allantoin, phytantriol, panthenol, AHA acids, amino acids, ceramides, pseudoceramides, essential oils, plant extracts, e.g. prunus extract, bambara nut extract and vitamin complexes.

Antioxidants break the photochemical reaction chain, which is initiated, if UV radiation penetrates the skin. Typical examples for this are amino acids (e.g. glycine, histidine, tyrosine, tryptophane) and their derivatives, imidazoles (e.g. urocanine acid) and their derivatives, peptides like D,L-carnosine, D-carnosine, L-carnosine and their derivatives (e.g. anserine), carotinoids, carotenes (e.g. α-carotene, β-carotene, lycopin) and their derivatives, chlorogenic acid and its derivatives, lipoic acid and its derivatives (e.g. dyhydrolipoic acid), aurothioglucose, propylthiouracil and other thiols (e.g. thioredoxin, glutathion, cysteine, cystine, cystamine and its glycosyl-, N-acetyl-, methyl-, ethyl-, propyl-, amyl-, butyl- and lauryl-, palmitoyl-, oleyl-, γ-linoleyl-, cholesteryl- and glyceryl esters) as well as their salts, dilaurylthiodipropionate, distearylthiodipropionate, thiodipropionic acid and its derivatives (ester, ether, peptides, lipids, nucleotids, nucleoside and salts) as well as sulfoximine compounds (e.g. buthioninsulfoximines, homocysteinsulfoximine, butioninsulfones, penta-, hexa-, heptathioninsulfoximine) in very small compatible doses (e.g. pmol to μmol/kg), further (metallic) chelating agents (e.g. α-hydroxy fatty acids, palmitic acid, phytic acid, lactoferrin), α-hydroxy acids (e.g. citric acid, lactic acid, malic acid), humic acid, gallic acid, gallic extracts, bilirubin, biliverdin, EDTA, EGTA and its derivatives, unsaturated fatty acids and their derivatives (e.g. γ-linolenic acid, linolic acid, oleic acid), folic acid and its derivatives, ubiquinone and ubiquinol and their derivatives, vitamin C and derivatives (e.g. ascorbyl palmitate, Mg-ascorbyl phosphate, ascorbyl acetate), tocopherols and derivatives (e.g. vitamin-E-acetate), vitamin A and derivatives (vitamin-A palmitate) as well as coniferyl benzoate of benzoin, rutinic acid and its derivatives, α-glycosylrutin, ferulic acid, furfurylidene glucitol, carnosine, butylhydroxy toluol, butylhydroxy anisole, nordihydro guaiacic acid, nordihydro guaiaretic acid, trihydroxyl-butyrophenone, uric acid and its derivatives, mannose and its derivatives, super oxide-dismutase, zinc and its derivatives (e.g. ZnO, ZnSO₄), selenium and its derivatives (e.g. selenium methionine), stilbene and its derivatives (e.g. stilbene oxide, trans-stilbene oxide) and the derivatives (salts, ester, ether, sugar, nucleotides, nucleosides, peptides and lipids) of these mentioned active agents suitable according to the invention.

Deodorants and Germination Inhibitors

Cosmetic deodorants (desdorants) act against body odors, mask or remove them. Body odors arise by the reaction of skin bacteria on hidden perspiration, whereby unpleasant-smelling decomposition products are formed. Deodorants contain correspondingly active agents, which function as germ inhibitors, enzyme inhibitors, odor absorbers or odor masking agent.

Germ Inhibitors

All materials effective against gram-positive bacteria are basically suitable as germ inhibitors, e.g.4-hydroxybenzoic acid and its salts and ester N-(4-chlorophenyl)-N′-(3,4-dichlorophenyl) urea, 2,4,4′-trichloro-2′-hydroxy-diphenyl ether (triclosane), 4-chloro-3,5-dimethyl-phenol, 2,2′-methylene-bis(6-brom-4chlorophenol), 3-methyl-4-(1-methylethyl)-phenol, 2-benzyl-4-chlorophenol, 3-(4-chlorophenoxy)-1,2-propandiol, 3-iodo-2-propinyl-butylcarbamate, chlorohexidine, 3,4,4′-trichlorocarbanilide (TTC), antibacterial perfumes, thymol, thyme oil,, eugenol, clove oil, menthol, mint oil, farnesol, phenoxyethanol, glycerolmonocaprinate, glycerol-monocaprilate, glycerolmonolaurate (GML), diglycerolmonocaprinate (DMC), salicylic acid-N-alkylamides e.g. salicylic acid-n-octylamide or salicylic acid-n-decyclamide.

Enzyme Inhibitors

Esterase inhibitors are, for instance, suitable as enzyme inhibitors. For this, triacylcitrate like trimethylcitrate, tripropylcitrate, triisopropylcitrate, tributylcitrate and particularly triethylcitrate (Hydagen® CAT) are preferable. The materials inhibit the enzyme activity and reduce thereby the odor formation. Additional materials, which are used as esterase inhibitors, are sterolsulfates or phosphates, e.g., lanosterin-, cholesterin, campesterin-, stigmasterin-, and sitosterin-sulfate or -phosphate, dicarboxylic acids and their esters, e.g. glutaric acid, glutaric acid monoethyl ester, glutaric acid diethyl ester, adipic acid, adipic acid monoethyl ester, adipic acid diethyl ester, malonic acid and malonic acid diethyl ester, hydroxycarboxylic acids and their esters e.g. citric acid, malic acid, tartaric acid or tartaric acid diethylester, as well as zinc glycinate.

Odor Absorber

Materials, which can receive and largely retain odor-forming compounds, are suitable as odor absorbers. They reduce the partial pressure of the individual components and thus also reduce their diffusion speed. Besides, it is important that perfumes must remain unaffected. Odor absorbers have no effect against bacteria. They contain as a main component, for instance, a complex zinc salt of ricinoleic acid or, specially, largely odor-neutral aromatic substances, which are known to specialists as “fixers”, e.g. extracts of labdanum or styrax or certain abietic acid derivatives. Scents or perfume oils function as odor masking agents, which in addition to their function as odor masking agents lend the deodorants their respective aromas. Mixtures of natural and synthetic fragrances may be, for instance, called perfume oils. Natural fragrances are extracts of flowers, stems and leaves, fruits, fruit peels, roots, wood, herbs and grasses, needles and branches as well as resins and balsams. Further, animal fragrances can be used, e.g. cibet and castoreum. Typical synthetic fragrance compounds are products like esters, ethers, aldehydes, ketones, alcohols and hydrocarbons. Fragrance compound esters are e.g. benzyl acetate, p-tert.-butylcyclohexylacetate, linalylacetate, phenylethylacetate, linalylbenzoate, benzylformate, allylcyclohexylpropionate, styrallylpropionate and benzylsalicylate. To the ethers can be added, for instance, benzylethylether, to the aldehydes, for instance, the linear alkanals with 8 to 18 carbon atoms, citral, citronellal, citronellyloxyacetaldehyde, cyclamenaldehyde, hydroxycitronellal, lilial and bourgeonal, to the ketones e.g. the ionines and methylcedrylketone, to the alcohols anethole, citronellol, eugenol, isoeugenol, geraniol, linalool, phenylethyl alcohol and terpinol, to the hydrocarbons belong mainly the terpene and balsams. However, preferably mixtures of different fragrances are used, which jointly produce a pleasant smell. Also essential oils of low volatility, which are mostly used as aroma components, are suitable as perfume oils, e.g. sage oil, camomile oil, clove oil, balm mint oil, mint oil, cinnamon leaf oil, lime blossom oil, juniper berry oil, vetiver oil, olibanum oil, galbanum oil, labdanum oil and lavandin oil. Preferably, bergamot oil, dihydromyrcenol, lilial, lyral, citronellol, phenylethyl alcohol, α-hexylzimtaldehyde, geraniol, benzylacetone, cyclamenaldehyde, linalool, boisambrene forte, ambroxane, indole, hedione, sandelice, lemon oil, mandarin oil, orange oil, allylamyl glycolate, cyclovertal, lavandin oil, clary sage oil, β-demascone, geranium oil bourbon, cyclohexylsalicylate, vertofix Coeur, iso-E-super, fixolide NP, evernyl, iraldein gamma, phenylacetic acid, geranyl acetate, benzylacetate, rose oxide, romilate, irtotyl and floramate are used alone or in mixtures.

Antiperspirants

Antiperspirants reduce the sweat formation by influencing the activity of the eccrine sweat glands and consequently act against armpit dampness and body odor. Aqueous or non-aqueous formulations of antiperspirants typically contain the following materials:
Active astringent agents,
Oil components,
Non-ionic emulsifiers,
Co-emulsifiers,
Consistency agents,
Additives e.g. thickeners, or complexing agents and/or
Non-aqueous solvents e.g. ethanol, propylene glycol and/or glycerol.

Above all, salts of aluminum, zirconium or zinc are suitable as active astringent antiperspirant agents. Such suitable antihydrotic effective active agents are e.g. aluminum chloride, aluminum chlorohydrate, aluminum dichlorohydrate, aluminum sesquichlorohydrate and their complex compounds e.g. with polypropylene glycol-1,2, aluminum hydroxylallantoinate, aluminum chloride tartrate, aluminum-zirconium-trichlorohyd rate, aluminum-zirconium-tetrachlorohyd rate, aluminum-zirconium-pentachlorohydrate and their complex compounds e.g. with amino acids like glycine. Besides that, usually oil-soluble and water-soluble additives can be contained in small quantities. Such oil-soluble additives can e.g. be:
Inflammation inhibiting, skin-protecting or fragrance essential oils,
Synthetic skin-protecting active agents and/or
Oil-soluble perfume oils.

Usual water-soluble additives are e.g. preservatives, water-soluble aromatic substances, pH-value setting agent, e.g. buffer mixtures, water-soluble thickeners, e.g. water-soluble natural or synthetic polymers e.g. xanthan gum, hydroxyethylcellulose, polyvinylpyrrolidone or high molecular weight polyethylene oxides.

Film Formers

Film formers can be, for instance, chitosan, microcrystalline chitosan, quaternized chitosan, polyvinylpyrrolidone, vinylpyrrolidone-vinylacetate copolymers, polymers of the acrylic acid series, quaternary cellulose derivatives, collagen, hyaluronic acid or its salts and similar compounds.

Anti-Dandruff Agents

As antidandruff active agents can be used pirocton olamine (1-hydroxyl-4-methyl-6-(2,4,4-trimethylpentyl)-2-(1H)-pyridinonmonoethanolamine salt), Baypival® (climbazole), Ketoconazol®, (4-acetyl-1{-4-[2-(2.4-dichlorphenyl) r-2-(1H-imidazol-1-ylmethyl)-1,3-dioxylane-c-4-ylmethoxy-phenyl}piperazine, ketoconazol, elubiol, selenium disulfide, sulfur colloidal, sulfur polyethylene glycolsorbitan monooleate, sulfur risinolpolyethoxylate, sulfur-tar distillate, salicylic acid (or in combination with hexachlorophene), undexylene acid monoethanolamide sulfosuccinate Na-salt, Lamepon® UD (protein-undecylenic acid condensate), zinc pyrithion, aluminum pyrithion and magnesium pyrithion/dipyrithion-magnesium sulfate.

Swelling Agents

Montmorillonites, clay mineral materials, pemulene as well as alkyl-modified carbopol types (Goodrich) serve as swelling agents for aqueous phases. Further suitable polymers or swelling agents can be taken from the overview of R. Lochhead in Cosm. Toil. 108, 95 (1993).

Insect Repellents

N,N-dietyl-m-toluamide, 1,2-pentandiol or ethyl butyl acetyl amino-propionates can be used as insect repellents.

Self-Tanning and Depigmentation Agents

Dihydroxyacetone is suitable as self-tanner. Arbutine, ferulic acid, kojic acid, coumaric acid and abscorbic acid (vitamin C) can be used as tyrosin inhibitors, which prevent the formation of melanin and find use in depigmentation agents.

Hydrotropes

Further, hydrotopes, e.g. ethanol, isopropyl alcohol or polyols, can be used for the improvement of the flow behaviour. Polyols, which come into consideration here, possess preferably 2 to 15 carbon atoms and minimum two hydroxyl groups. The polyols can contain several more functional groups, especially amino groups, or be modified with nitrogen. Typical examples are
Glycerol;
Alkylene glycols, e.g. ethylene glycol, diethylene glycol, propylene glycol, butylene glycol, hexylene glycol as well as polyethylene glycol with an average molecular weight of 100 to 1,000 Dalton;
Technical oligoglycerol mixtures with an inherent condensation degree of 1.5 to 10, also technical diglycerol mixtures with a diglycerol content of 40 to 50% by weight;
Methylol compounds, especially trimethylolethane, trimethylolpropane, trimethylolbutane, pentaerythritol and dipentaerythritol;
Low alkylglucosides, preferably with 1 to 8 carbon atoms in the alkyl radical, e.g. methyl- and butyl-glucoside;
Sugar alcohols with 5 to 12 carbon atoms, e.g. sorbitol or mannitol,
Sugar with 5 to 12 carbon atoms, e.g. glucose or saccharose;
Amino sugars, e.g. glucamine
Dialcoholamines, like diethanolamine or 2-amino-1,3-propandiol

Preservative

Phenoxyethanol, formaldehyde solution, parabens, pentanediol or sorbic acid as well as silver complexes known under the brand Surfacine® and the additional classes of materials given in annexure 6, Part A and B of the cosmetic regulation are, for instance, suitable as preservatives.

Perfume Oils and Aromas

Mixtures of natural and synthetic fragrances are called perfume oils. Natural fragrances are extracts of flowers (lily, lavender, rose, jasmine, neroli, ylang-ylang), stems and leaves (geranium, patchouli, petitgrain), fruits (aniseed, coriander, cumin, juniper), fruit peels (bergamot, lemon, orange), roots (mace, angelica, celery, cardamom, costus, iris, calmus), woods (pine-, sandal-, guaiac-, cedar-, rose-wood), herbs and grasses (tarragon, lemongrass, sage, thyme), needles and twigs (spruce, pine, stone pine, dwarf pine), resins and balsams (galbanum, elemi, benzoin, myrrh, olibanum, opoponax). Further animal raw materials can be used e.g. civet and castoreum. Typical synthetic fragrances are products of the type esters, ethers, aldehydes, ketones, alcohols and hydrocarbons. Fragrances of the ester type are e.g. benzyl acetate, phenoxyethylisobutyrate, p-tert.-butylcyclohexylacetate, linalylacetate, dimethylbenzylcarbinylacetate, phenylethylacetate, linalylbenzoate, benzylformate, ethylmethyl-phenylglycinate, allylcyclohexylpropionate, styrallylpropionate and benzylsalicylate. To the ethers can be counted, for instance, benzylethylether, to the aldehydes, for instance, the linear alkanals with 8 to 18 carbon atoms, citral, citronellal, citronellyloxyacetaldehyde, cyclamenaldehyde, hydroxycitronellal, lilial and bourgeonal, to the ketones e.g. the ionines, α-isomethylionon and methylcedrylketone, to the alcohols anethol, citronellol, eugenol, isoeugenol, geraniol, linalool, phenylethyl alcohol and terpineol, to the hydrocarbons belong mainly the terpene and balsams. However, preferably mixtures of different fragrances are used, which jointly produce a pleasing smell. Also essential oils of low volatility, which are mostly used as aroma components, are suitable as perfume oils, e.g. sage oil, camomile oil, clove oil, melissa oil, mint oil, cinnamon leaf oil, lime blossom oil, juniper berry oil, vetiver oil, oliban oil, galbanum oil, labolanum oil and lavandin oil. Preferably, bergamot oil, dihydromyrcenol, lilial, lyral, citronellol, phenylethyl alcohol, α-hexylzimtaldehyde, geraniol, benzylacetone, cyclamenaldehyde, linalool, boisambrene forte, ambroxane, indole, hedione, sandelice, lemon oil, mandarin oil, orange oil, allylamyl glycolate, cyclovertal, lavandin oil, clary sage oil, β-demascone, geranium oil bourbon, cyclohexylsilicate, Vertofix Coeur, iso-E-super, fixolide NP, evernyl, iraldein gamma, phenylacetic acid, geranyl acetate, benzylacetate, rose oxide, romilate, irtotyl and floramate are used alone or in mixtures.

As aromas can be used, for instance, peppermint oil, spearmint oil, aniseed oil, staranise oil, cuminseed oil, eucalyptus oil, oil of fennel, lemon oil, wintergreen oil, clove oil, menthol and such others.

Coloring Agents

Substances suitable and permitted for cosmetic purposes can be used as coloring agents, like those, for instance, compiled in the publication “Cosmetic coloring agents” of the Dyestuff commission of the German research association, Publication Chemistry, Weinheim, 1984, S.81-106. Examples are Acid red A (C.I. 16255), patent blue V (C.I.42051), indigotin (C.I.73015), chlorophyllin (C.I.75810), quinoline yellow (C.I.47005), titanium dioxide (C.I.77891), indanthrone RS (C.I. 69800) and madder black (C.I.58000). Also luminol may be used as a luminescent coloring agent. These coloring agents are usually used in concentrations of 0.001 to 0.1% by weight with reference to the total mixture.

The total proportion of the auxiliary agents and additives can amount to 1% to 50%, preferably 5% to 40% by weight, with reference to the preparation. The manufacturing can be undertaken by the usual cold or hot processes; preferably one works according to the phase-inversion temperature method.

Washing, Rinsing, Cleaning and Softening Agents

The sulfosuccinates or surfactant mixtures according to the invention can also be used for the manufacture of washing, rinsing, cleaning and softening agents. Preferably, for production of manual dishwashing formulations. The mentioned preparations can contain typical auxiliary agents and additives e.g. the already mentioned anionic, non-ionic, cationic, amphoteric or zwitterionic co-surfactants and in addition builders, co-builders, oil- and fat-dissolving materials, bleaching agents, bleaching activators, greying inhibitors, enzymes, enzyme stabilisers, optical brighteners, polymers, antifoam agents, spraying agents, perfumes, inorganic salts and such others, as explained in detail below.

Builders

The preparation according to the invention can contain inorganic and organic builder substances, for instance in quantities of 10% to 50% and preferably 15% to 35% by weight with reference to the preparation, in which mainly zeolites, crystalline layered silicates, amorphous silicates and—as long as permitted—also phosphates, e.g. tripolyphosphate are used. Besides, the quantity of co-builder has to be taken into account for the preferred quantities of phosphates.

Zeolites

The fine-crystalline, synthetic and water-bound zeolite frequently used as washing agent builder is preferably zeolite A and/or P. For example, Zeolite MAP® (commercial product of the company Crosfield) is particularly preferred as zeolite P. However, zeolite X as well as mixtures from A, X and/or P as well as Y are also suitable. Of particular interest is also a co-crystallized sodium/potassium-aluminum silicate from zeolite A and zeolite X, which is available commercially as VEGOBOND AX® (commercial product of the company Condea Augusta S.p.A). The zeolite can be used as spray-dried powder or also as not dried, still damp from its manufacture, stabilized suspension. If the zeolite is used as a suspension, this can contain small additions of non-ionic surfactants as stabilisers, for instance 1 to 3 % by weight with reference to zeolite, of ethoxylated C₁₂-C₁₈ fatty alcohols with 2 to 5 ethylene oxide groups, C₁₂-C₁₄ fatty alcohols with 4 to 5 ethylene oxide groups or ethoxylated isotridecanols. Suitable zeolites exhibit average particle size of less than 10 μm (volume distribution; measuring method: Coulter counter) and contain preferably 18 to 22% by weight, particularly 20 to 22% by weight, of bound water.

Layered Silicates

Suitable substitutes or partial substitutes for phosphates and zeolites are crystalline, layered sodium silicates of the general formula NaMSiₓO₂ₓ₊₁.yH₂O, in which M means sodium or hydrogen, x is a number from 1.9 to 4 and y a number from 0 to 20 and preferred values for x are 2,3 or 4. Preferred crystalline layered silicates of the indicated formula are such, in which M represents sodium and x takes the values 2 or 3. Both β-as well as δ-sodium silicates Na₂Si₂O₅.yH₂O are especially preferred. Their usability is not limited to a special composition or structural formula. However, smectites, particularly bentonites, are preferred. Suitable layered silicates, which belong to the group of smectites capable of swelling with water, are e.g. of the general formulae
(OH)₄Si_{8-y}Al_{y}(MgₓAl₄₋ₓ)O₂₀ Montmorrilonite
(OH)₄Si_{8-y}Al_{y}(Mg_{6-z}Li_{z})O₂₀ Hectorite
(OH)₄Si_{8-y}Al_{y}(Mg_{6-z}Al_{z})O₂₀ Saponite
with x=0 to 4, y=0 to 2, z=0 to 6. In addition, small amounts of iron can be incorporated in the crystalline lattice of the layered silicates according to the above formulae. Further, the layered silicates can contain hydrogen-, alkali-, alkaline earth ions, particularly Na⁺ and Ca²⁺, due to their ion exchanging properties. The water of hydration amount lies mostly in the range of 8 to 20% by weight and depends on the swelling condition or on the type of the processing. Stratified silicates, which are largely free from calcium ions and strong coloring iron ions due to an alkali treatment, are preferably used.

Amorphous sodium silicate with a ratio Na₂O:SiO₂ of 1:2 to 1:3.3, preferably from 1:2 to 1:2.8 and particularly from 1:2 to 1:2.6, which are slow dissolving and exhibit secondary washing properties, also belong to the preferred builder substances. The slow dissolving rates compared to usual amorphous sodium silicates can be produced by different methods, for instance by surface treatment, compounding, compacting/compression or by over-drying. In the framework of this invention, the term “x-ray amorphous” is also understood under the term “amorphous”. That is, that the silicates do not deliver any sharp X-ray patterns for X-ray diffraction experiments as are typical for crystalline substances, but in all cases one or more maxima of the scattered X-rays, which exhibit a width of several degrees of the diffraction angle. However, it can very well lead even to especially good builder properties, if the silicate particles deliver for electron diffraction experiments deformed or even sharp diffraction maxima. This has to be so interpreted that the products exhibit microcrystalline ranges of the size 10 nm to few hundreds nm, in which values up to max. 50 nm and particularly up to max. 20 nm are preferred. Compressed/compacted amorphous silicates, compounded amorphous silicates and over-dried X-ray amorphous silicates are particularly preferred.

Phosphates

It is also obvious that it is possible to use the generally known phosphates as builder substances, as long as such a use is permissible on ecological grounds. The sodium salts of the orthophosphates, the pyrophosphates and especially tripolyphosphates are particularly suitable. Their content amounts generally to not more than 25% by weight, preferably not more than 20% by weight, with reference to the finished preparation. In some cases it has been shown that especially tripolyphosphates, in small quantities up to a maximum of 10% by weight with reference to the finished preparation, in combination with other builder substances, lead to a synergistic improvement of secondary washing ability.

Cobuilder

Usable organic substances, which can be considered as co-builders, are, for instance, the polycarboxylic acids such as citric acid, adipic acid, succinic acid, glutaric acid, tartaric acid, sugar acids, aminocarboxylic acids, nitrilotriacetic acid (NTA), which can be used in the form of their sodium salts, as long as there is no objection to such a use on ecological grounds, as well as mixtures of these. Preferred salts are the salts of the polycarboxylic acids like citric acid, adipic acid, succinic acid, glutaric acid, tartaric acid, sugar acids and mixtures thereof. Even the acids by themselves can be used. Along with their builder effect, the acids typically also possess the properties of an acidification complex and hence can be used for setting a lower or a milder pH-value of detergents or cleaning agents. The acids especially used here are citric acid, succinic acid, glutaric acid, adipic acid, gluconic acid and any mixtures thereof.

Dextrins

Further suitable organic builder substances are dextrins, such as oligomers or polymers of carbohydrates, which can be obtained through a partial hydrolysis of their starches. The hydrolysis can be done according to the usual methods of acid or enzyme catalysis. Preferred here are the hydrolysis products with average molar masses in the range of 400 to 500,000. Preferred is a polysaccharide with a dextrose equivalent (DE) in the range of 0.5 to 40, especially 2 to 30, where DE is the usual measure for the reducing effect of a polysaccharide as compared to dextrose, which has a DE of 100. Usable are also the maltodextrins with a DE between 3 and 20 and dry glucose syrups with a DE between 20 and 37 as well as the so-called yellow dextrins and white dextrins with higher molecular weights in the range of 2,000 to 30,000. The oxidized derivatives of such dextrins are the conversion products with oxidizing agents, which are capable of oxidizing at least one alcohol function of the saccharide ring to the carboxylic acid function.

Succinate

Other suitable co-builders are oxydisuccinates and other derivatives of disuccinates, preferably ethylenediamine disuccinate. Especially preferred here are also glycerol disuccinate and glycerol trisuccinate. In zeolite- or silica containing formulations, the suitable required quantities lie in the range of 3 to 15 wt-%. Other suitable organic co-builders are, for instance, acetylated hydroxylcarboxylic acids or their salts, which can also be present in lactone form and which contain at least 4 carbon atoms and at least one hydroxyl group as well as maximum two acidic groups.

Polycarboxylates

Suitable polymeric polycarboxylates are, for instance, the sodium salts of the polyacrylic acid or of polymethacrylic acid, such as the ones with a relative molecular weight of 800 to 150,000 (with reference to the acid and respectively measured against polystyrenesulfonic acid). Suitable copolymeric polycarboxylates are, especially those of acrylic acid with methacrylic acid and of acrylic acid or methacrylic acid with maleic acid. Copolymers of acrylic acid with maleic acid have proved to be especially suitable, which contain 50 to 90 wt.-% of acrylic acid and 50 to 10 wt.-% of maleic acid. Their relative molecular weight, with respect to the free acids is generally 5,000 to 200,000, preferable 10,000 to 120,000, and especially 50,000 to 100,000 (measured against polystyrenesulfonic acid respectively). The (co-) polymeric polycarboxylates can either be used as a powder or in an aqueous solution, whereby 20 to 55 wt.-% aqueous solutions are preferred. Granular polymers are mostly mixed later on with one or more base granulates. Especially preferred are the biodegradable polymers made of two or more different monomer units. Similarly, other preferred builder substances are polymeric amino-dicarboxylic acids, their salts or their precursor substances. Especially preferred are polyasparginic acids, their salts and derivatives.

Polyacetals

Other suitable builder substances are polyacetals, which are obtained from the conversion of dialdehydes with polycarboxylic acids, which have 5 to 7 C atoms and at least 3 hydroxyl groups. Preferred polyacetals are obtained from dialdehydes such as glyoxal, glutaraldehyde, terephthaldehyde as well as their mixtures and from polycarboxylic acids such as gluconic acid and/or glucoheptonic acid.

Oils and Fat-Dissolving Substances

In addition, the agents can also contain components, which positively influence the washing of oils and fats from textiles. The preferred oil and fat dissolving substances include, for instance, nonionic cellulose ethers like methyl cellulose and methoxyhydroxypropylcellulose with a percentage of methoxy groups of 15 to 30 wt.-% and of hydroxylpropyl groups of 1 to 15 wt.-% respectively with reference to the non-ionic cellulose ether as well as the known polymers of phthalic acid and/or terephthalic acid or their derivatives, especially the polymers of ethylene terephthalates and/or polyethylene glycolterephthalates or anionic and/or non-ionic modified derivatives thereof. Especially preferred are the sulfonated derivatives of phthalic acid and terephthalic acid polymers.

Bleaching Agents and Bleaching Activators

Among the compounds acting as bleaching agents, which give off H₂O₂ in water, sodium perborate tetrahydrate and sodium perborate monohydrate are especially important. Other usable bleaching agents are, for instance, sodium percarbonate, peroxypyrophosphate, citrate perhydrate as well as H₂O₂ supplying peracidic salts or peracids, such as perbenzoic, peroxyphthalic, diperazeleic acid, phthaloiminoperacid or diperdodecanoic acid. The content of the bleaching agent in the medium is preferably 5 to 35 wt.-% and especially about 30 wt.-%, in which connection preferably perborate monohydrate or percarbonate are used.

As bleaching activators, the compounds can be used, which under perhydrolysis conditions result in aliphatic peroxycarboxylic acids with preferably 1 to 10 C atoms, especially 2 to 4 C atoms, and/or also substituted perbenzoic acid. Suitable substances are the ones, which carry the O—and/or the N-acyl groups of the named number of C atoms and/or the substituted benzoyl groups. Preferred are the polyacylated alkylenediamines, especially tetracetylethylenediamine (TAED), acylated triazine derivative, especially 1,5-diacetyl-2,4-dioxohexahydro-1,3,5-triazine (DADHT), acylated glycourils, especially tetraacetyl glycouril (TAGU), N-acylimides, especially N-nonoylsuccinimide (NOSI), acylated phenol sulfonate, especially n-nonoyl or isononoyl-oxybenzolsulfonate (n- or iso-NOBS), carboxylic acid anhydrides, especially phthalic acid anhydride, acylated multivalent alcohols, especially triacetin, ethylene glycol diacetate, 2,5-diacetoxy-2,5-dihydrofuran, enolesters such as acylated sorbitol and mannitol or their acylated sugar derivatives, especially pentaacetyl glucose (PAG), pentaacetyl fructose, tetraacetyl xylose and octaacetyl lactose as well as acylated, possibly N-alkylated glucamine and gluconolactone, and/or N-acylated lactames, for instance, N-benzoylcaprolactam. Such derivatives are contained in the normal quantity range, preferably in the range of 1 wt.-% to 10 wt.-%, especially 2 wt.-% to 8 wt.-%, with reference to the entire medium. In addition to the conventional bleaching activators mentioned above, or in their place, sulfonimines and/or bleaching-reinforcing transition metal salts or transition metal complexes respectively can be contained as bleaching catalysts. The relevant transition metal compounds that can be used to include salt complexes of manganese, iron, cobalt, ruthenium or molybdenum and their N analog compounds, carbonyl complexes of manganese, iron, cobalt, ruthenium or molybdenum, manganese, iron, cobalt, ruthenium, molybdenum, titanium, vanadium and copper complexes with nitrogen-containing ligands as well as cobalt, iron, copper and ruthenium-amine complexes. Bleaching-reinforcing transition metal complexes, especially with the central atoms Mn, Fe, Co, Cu, Mo, V, Ti and/or Ru are used in usual quantities, preferably in a quantity up to 1 wt.-%, especially 0.0025 wt.-% to 0.25 wt.-% and especially preferred 0.01 wt.-% to 0.1 wt.-% with reference to the entire medium.

Enzymes and Enzyme Stabilisers

As enzymes, the relevant ones are from, the class of hydrolases, such as the proteases, esterases, lipases or lipolytic-active enzymes, amylases, cellulases or other glycosyl-hydrolases and mixtures of the mentioned enzymes. While washing, all these enzymes contribute to the removal of spots, like the spots-containing proteins, fats or starch, and greying. Owing to the removal of pilling and microfibrils, cellulases and other glycosyl-hydrolases also prevent the loss of color and enhance the softness of the textile. Oxidoreductases can also be used for bleaching or for inhibiting the color transfer. Especially suitable are the enzymatic substances extracted from bacterial strains or fungi, such as bacillus subtilis, bacillus licheniformis, streptomyces griseus and humicola insolens. Preferably used are the proteases of the subtilis type and especially the proteases extracted from bacillus lentus. Thereby, of special interest are the enzyme mixtures, such as mixture of protease and amylase or protease and lipase or lipolytic-active enzymes or protease and cellulase or mixtures of cellulase and lipase or lipolytic-active enzymes or mixtures of protease, amylase and lipase or lipolytic-active enzymes or protease, lipase or lipolytic-active enzymes and cellulase, especially however protease and/or lipase-containing mixtures or mixtures with lipolytic-active enzymes. Examples of such lipolytic-active enzymes are the known cutinases. Even peroxidases or oxidases have proved to be useful in some cases. The suitable amylases include especially α-amylases, iso-amylases, pullulanases and pectinases. The preferably used cellulases are cellobiohydrolases, endoglucanases and β-glucosidases, which are also known as cellobiases, or mixtures of these. Since the different cellulase types differ in their CMCase- and avicelase activities, the desired activity can be set by using specific mixtures of cellulases.

The enzymes can be adsorbed on carrier substances and/or embedded in shell substances, in order to protect them against premature degradation. The percentage of enzymes, enzyme mixtures or enzyme granules can, for instance, be 0.1 to 5 wt.-%, preferably 0.1 to about 2 wt.-%.

In addition to the mono- and polyfunctional alcohols, the medium can contain other enzyme stabilisers. For example, 0.5 to 1 wt.-% of sodium formate can be used. It is also possible to use the proteases, which are stabilized with soluble calcium salts and a calcium content of preferably about 1.2 wt.-% with reference to the enzyme. Apart from calcium salts, magnesium salts also act as stabilisers. Of special advantage is, however, the use of boron compounds, such as boric acid, boric oxide, borax and other alkali-metal borates such as the salts of orthoboric acid (H₃BO₃), metaboric acid (HBO₂) and pyroboric acid (tetraboric acid H₂B₄O₇).

Greying Inhibitors

The task of the greying inhibitors is to keep the dirt released from the fiber suspended in the liquor and thus prevent a reabsorption of the dirt. For this, organic water-soluble colloids are mostly suitable, such as the water-soluble salts of the polymeric carboxylic acids, glue, gelatins, salts of ether carboxylic acids or ethersulfonic acids of starch or cellulose or salts of sulfuric acid esters of cellulose or of starch. Even water-soluble polyamides containing acidic groups are suitable for this purpose. Further, soluble starch preparations and the starch products mentioned above can also be used e.g. degraded starches, aldehyde starches etc. Even polyvinylpyrrolidone can be used. However, preferred are cellulose ethers such as carboxymethylcellulose (Na salt), methylcellulose, hydroxylalkyl cellulose and mixed ethers such as methylhydroxyethyl-cellulose, methylhydroxypropylcellulose, methylcarboxymethylcellulose and their mixtures as well as polyvinylpyrrolidone in quantities of 0.1 to 5 wt.-%, with reference to the medium.

Optical Brighteners

The medium can contain derivatives of diaminostilbendisulfonic acid or its alkali metal salts as optical brighteners. Suitable, for instance, are the salts of 4,4′-bis(2-anilino-4-morpholino-1,3,5-triazinyl-6-amino)stilben-2,2′-disulphonic acid or compounds with an equivalent structure, which carry a diethanolamino group, a methylamino group, an aniline group or a 2-methoxyethylamino group in place of the morpholino group. Further, brighteners of the diphenylstyryl type can also be present e.g. the alkali salts of 4,4′-bis(2-sulfostyryl)-diphenyl, 4,4′-bis(4-chloro-3-sulfostyryl)-diphenyl or 4-(4-chlorostyryl)-4′-(2-sulfostyryl)-diphenyl. Mixtures of the brighteners mentioned can also be used. Uniform white granulate are obtained when the medium also contains small quantities e.g. 10⁻⁶ to 10⁻³ wt.-%, preferably around 10⁻⁵ wt.-% of a blue dye apart from the usual brighteners in the usual quantities e.g. between 0.1 and 0.5 wt.-%, preferably between 0.1 and 0.3 wt.-%. An especially preferred dye is Tinolux® (commercial product of Ciba-Geigy).

Polymers

As “soil-repellant” polymer substances, which preferably contain ethylene terephthalate and/or polyethyleneglycol terephthalate groups, where the molar ratio of ethylene terephthalate to polyethyleneglycol terephthalate can lie in the range of 50:50 to 90:10. The molecular weight of the linking polyethyleneglycol units lies especially in the range of 750 to 5000 i.e. the degree of ethoxylation of the polyethyleneglycol group containing polymers can be between 15 to 100. The polymers are characterised by an average molecular weight of 5,000 to 200,000 and can show a block, but preferably a random structure. Preferred polymers are the ones with molar ratios of ethylene terephthalate/polyethyleneglycol terephthalate of about 65:35 to about 90:10, preferably of about 70:30 to 80:20. Further preferred are such polymers, which contain linking polyethyleneglycol units with a molecular weight of 750-5000, preferably of about 1000 to 3000 and a molecular weight of the polymer of about 10,000 to 50,000. Examples of commercial polymers are the products Milease® T (ICI) or Repelotex) SRP 3 (Rhone-Poulenc)

Defoaming Agents

Waxlike compounds can be used as defoaming agents. “Waxlike” means such compounds, which have a melting point above 25° C. (room temperature) at atmospheric pressure, preferably above 50° C. and especially above 70° C. The waxlike defoaming substances are practically insoluble in water i.e. at 20° C. they show a solubility of under 0.1 wt.-% in 100 g of water. In principle, all the known waxlike substances can be included. Suitable waxlike compounds are, for instance, bisamides, fatty alcohols, fatty acids, carboxylic acid esters of mono- and poly- alcohols as well as paraffin wax or mixtures thereof. Alternatively, the known silicone compounds can also naturally be used for this purpose.

Paraffin Wax

Suitable paraffin waxes generally represent a complex mixture without a definite melting point. For characterisation, one normally determines the melting range with the help of differential thermoanalysis (DTA) and/or the solidification point. That is the temperature, at which the paraffin wax makes a transition from liquid to solid state through slow cooling. Hence, the paraffins which are completely liquid at room temperature i.e. the ones with a solidification point below 25° C., are not usable in the invention. The soft waxes, which have a melting point in the range of 35 to 50° C., include preferably the group of petrolates and their hydration products. They are made of microcrystalline paraffin and up to 70 wt.-% of oil, possess an ointment-like to a plastic-solid consistency and represent bitumen-free residues from the processing of crude oil. Especially preferred are the distillation residues (petroleum jelly) of specific paraffin-based and mixed-based crude, which are further processed to make vaseline. Preferably they are bitumen-free oily to solid hydrocarbons separated out with the help of solvents from the distillation residues of paraffin and mixed-based crude and cylinder-oil distillates. They have a semi-solid, smooth, sticky to plastic-solid consistency and possess melting points between 50 and 70° C. These petrolates represent the most important starting basis for the manufacture of microwaxes. Further suitable are the solid hydrocarbons separated out from highly viscous, paraffin-containing lubricant oil distillates during dewaxing with melting points between 63 and 79° C. These petrolates are mixtures of microcrystalline waxes and high-melting n-paraffins. For instance, paraffin wax mixtures of 26 wt.-% to 49 wt.-% microcrystalline paraffin waxes with a solidification point of 62 to 90° C., 20 wt.-% to 49 wt.-% hard paraffin with a solidification point of 42 to 56° C. and 2 wt.-% to 25 wt.-% soft paraffin with a solidification point of 35 to 40° C. can be used. Preferably, paraffin or paraffin mixtures are used, which solidify in the range of 30° C. to 90° C. Thereby, it is to be noted that paraffin wax mixtures appearing solid at room temperature can contain different proportions of liquid paraffin. In the case of usable paraffin waxes of the invention, the liquid portion is as low as possible or else preferably is totally absent. Thus, especially preferred paraffin wax mixtures at 30° C. show a liquid portion of below 10 wt.-%, especially of 2 wt.-% to 5 wt.-%, at 40° C. a liquid portion of below 30 wt.-%, preferably of 5 wt.-% to 25 wt.-% and especially of 5 wt.-% to 15 wt.-%, at 60° C. a liquid portion of 30 wt.-% to 60 wt.-%, especially of 40 wt.-% to 55 wt.-%, at 80° C. a liquid portion of 80 wt.-% to 100 wt.-% and at 90° C. a liquid portion of 100 wt.-%. The temperature, at which a liquid portion of 100 wt.-% of the paraffin wax is reached, lies below 85° C. in case of especially preferred paraffin wax mixtures, especially at 75° C. to 82° C. The paraffin waxes can be petroleum jelly, microcrystalline waxes and hydrated or partially hydrated paraffin waxes.

Bisamides

Suitable bisamides as defoaming agents are such, which are derived from saturated fatty acids with 12 to 22, preferably 14 to 18 C atoms as well as from alkylenediamines with 2 to 7 C atoms. Suitable fatty acids are laurinic, myristic, stearic, arachinic and behenic acid as well as mixtures thereof, as these are available from natural fats or from hydrogenated oils such as tallow or hydrogenated palm oil. Suitable diamines are, for instance, ethylenediamine, 1,3-propylenediamine, ter-methylenediamine, pentamethylenediamine, hexamethylenediamine, p-phenylenediamine and tolulenediamine. Preferred diamines are ethylenediamine and hexamethylenediamine. Especially preferred bisamides are bismyristoylethylenediamine, bispalmitoylethylenediamine, bisstearoylthylenediamine and mixtures thereof as well as the corresponding derivatives of hexamethylenediamine.

Carboxylic Acid Esters

Suitable carboxylic acid esters as defoaming agents are derived from carboxylic acids with 12 to 28 carbon atoms. Especially, these are the esters of behenic acid, stearic acid, hydroxystearic acid, oleic acid, palmitic acid, myristic acid and/or lauric acid. The alcohol portion of the carboxylic acid esters contains a mono or polyhydroxyl alcohol with 1 to 28 carbon atoms in the hydrocarbon chain. Examples of suitable alcohols are behenyl alcohol, arachidyl alcohol, coconut alcohol, 12-hydroxystearyl alcohol, oleyl alcohol and lauryl alcohol as well as ethylene glycol, glycerin, polyvinylalcohol, saccharose erythrite, pentaerythrit, sorbitan and/or sorbit. Advantageous esters are ethylene glycol, glycerin and sorbitan, where the acid portion of the ester is selected especially from behenic acid, stearic acid, oleic acid, palmitic acid or myristic acid. Relevant esters of multivalent alcohols are, for instance, xylitolmonopalmitate, pentarythritolmonostearate, glycerin monostearate, ethylene glycol monostearate and sorbitan monostearate, sorbitan mono palmitate, sorbitan monolaurate, sorbitan dilaurate, sorbitan distearate, sorbitan dibehenate, sorbitan dioleate as well as mixed tallow sorbitan mono and diester. Usable glycerin esters are the mono-, di-, or triesters of glycerin and the mentioned carboxylic acids, where the mono- and diesters are preferred. Glycerin monostearate, glycerin monooleate, glycerin monopalmitate, glycerin monobehenate and glycerin distearate are examples of useful glycerol esters. Examples of suitable natural esters as defoaming agents are beeswax, which consists mainly of the esters CH₃(CH₂)₂₄COO(CH₂)₂₇CH₃ and CH₃(CH₂)₂₆COO(CH₂)₂₅CH₃, and carnauba wax, which is a mixture of carnaubic acid alkyl esters, often in combination with small portions of free carnaubic acid, further long-chained acids, high-molecular alcohols and hydrocarbons.

Carboxylic Acids

Suitable carboxylic acids as additional defoaming agents are especially behenic acid, stearic acid, oleic acid, palmitic acid, myristic acid and lauric acid as well as mixtures thereof, as they are available from natural fats or from hydrogenated oils, such as tallow or hydrogenated palm oil. Preferred are the saturated fatty acids with 12 to 22, especially 18 to 22 C atoms. In the same way, the corresponding fatty alcohols of equal C-chain lengths can also be used.

Dialkyl Ether and Ketone

Further, dialkyl ethers can also be used as defoamers. The ethers can have an asymmetric or also a symmetric structure i.e. can contain two identical or different alkyl chains, preferably with 8 to 18 carbon atoms. Typical examples are di-n-octyl ether, di-i-octyl ether and di-n-stearyl ether, especially suitable are dialkyl ethers, which have a melting point above 25° C., especially above 40° C. Other suitable defoaming compounds are fatty ketones, which can be obtained from the relevant methods of the preparative organic chemistry. For producing these ketones, one starts with, for instance, carboxylic acid magnesium salts, which are pyrolysed at temperatures above 300° C. with splitting of carbon dioxide and water. Suitable fatty ketones are those which are manufactured from the pyrolysis of the magnesium salts of lauric acid, myristic acid, palmitic acid, palmitoleic acid, stearic acid, oleic acid, elaidic acid, petroselinic acid, arachidic acid, gadoleic acid, behenic acid or erucic acid.

Fatty Acid Polyethylene Glycol Esters

Further suitable defoamers are the fatty acid polyethylene glycol esters, which are preferably obtained through basic, homogeneous, catalysed addition of ethylene oxide to fatty acids. The addition of ethylene oxide to the fatty acids is especially done in the presence of alkanolamines as catalysts. The use of alkanolamines, especially triethanolamine, leads to an extremely selective ethoxylation of the fatty acids, especially when the aim is to produce low ethoxylated compounds. Within the group of fatty acid polyethylene glycol esters, those are preferred, which have a melting point of above 25° C., especially above 40° C.

Silicones

Suitable silicones are normal organopolysiloxanes, which have a content of fine silicic acid, which in turn can also be silanated. Especially preferred are the polydiorganosiloxanes and especially polydimethylsiloxanes, which are commercially available. Suitable polydiorganosiloxanes have an almost linear chain and show an oligomerisation degree of 400 to 1500. Examples of suitable substituents are methyl, ethyl, propyl, isobutyl, tertiary butyl and phenyl. Other suitable substituents are amino-, fatty acid-, alcohol-, polyether-, epoxy-, fluoro-, glycoside- and/or alkyl-modified silicon compounds, which can occur in a liquid state and also in the form of resins at room temperature. Other suitable siloxanes are simethicones, which are mixtures of dimethicones with an average chain length of 200 to 300 dimethyl-siloxane units and hydrogenated silicates. Normally, the silicones, in general, and the polydiorganosiloxanes especially contain especially fine silica, which can also be silanated. Especially suitable in the sense of the present invention are the silica-containing dimethylpolysiloxanes. Advantageously, the polydiorgano-siloxanes have a viscosity, according to Brookfield at 25° C. (spindle 1, 10 rpm) in the range of 5000 mPas to 30,000 mPas, especially from 15,000 to 25,000 mPas. Preferably, the silicones are used in the form of their aqueous emulsions. Normally, one adds silicone to water under stirring. If desired, the viscosity of the aqueous silicon emulsion can be increased by using any commercially available thickening agents. The thickening agents can be inorganic and/or organic, especially preferred are the non-ionic cellulose ethers such as methyl cellulose, ethylcellulose, and mixed ethers such as methylhydroxyethyl cellulose, methylhydroxypropylcellulose, methylhydroxybutylcellulose as well anionic carboxycellulose types such as the carboxymethylcellulose-sodium salt (short form CMC). Especially suitable thickeners are the mixtures of CMC with non-ionic cellulose ethers in the weight ratio of 80:20 to 40:60, preferably 75:25 to 60:40. Normally, the described thickener mixtures, are used in concentrations of 0.5 to 10, preferably of 2.0 to 6 wt.-%—calculated as thickener mixture based on the aqueous silicone emulsion, are recommended. The content of the described silicones in the aqueous emulsions lies preferably in the range of 5 to 50 wt.-%, especially between 20 and 40 wt.-%—calculated as silicone based on the aqueous silicone emulsion. As per another advantageous formulation, the aqueous silicone emulsions contain starch as a thickener, which can be obtained from natural sources, for instance, from rice, potatoes, maize and wheat. The starch is preferably present in quantities of 0.1 to 50 wt.-%—with reference to the silicone emulsion—and especially in mixtures with the already described thickener mixtures of sodium carboxymethylcellulose and a non-ionic cellulose ether in the above-mentioned quantities. For producing the aqueous silicone emulsion one proceeds in such a way that one adds the thickening agent to the water and lets it stand, before adding the silicone. The mixing of silicone is done with the help of suitable mixing and stirring devices.

Within the group of the waxy defoaming agents, the described paraffin waxes are especially preferred and are used as defoaming agents alone or in mixture with one or more waxy defoaming agents, where the proportion of the paraffin waxes in the mixture preferably makes up more than 50 wt.-%—with respect to the waxy defoaming agent mixture. If required, the paraffin waxes can be applied on the carrier. All the known inorganic and organic carrier substances are suitable as carriers. Examples of typical inorganic carrier substances are alkali carbonates, aluminum silicates, waterless layered silicates, alkali silicates, alkali sulfates, such as sodium sulfate, and alkali phosphate. The alkali silicates are preferably compounds with a molar ratio of alkali oxide to SiO₂ of 1:1.5 to 1:3.5. The use of such silicates results in especially good particle size properties, especially high abrasion stability and still higher dissolution speed in water. The aluminum silicates designated as carrier substances include the zeolites, such as zeolite NaA and NaX. The compounds known as water-soluble layered silicates include, for instance, amorphous or crystalline water glass. Further, the silicates can be used, which are available in the market under the trade names of Aerosil® or Sipernat®. Examples of the organic carrier substances are film-forming polymers, such as polyvinyl alcohols, polyvinyl pyrrolidone, poly(meth)acrylate, polycarboxylate, cellulose derivatives and starch. Usable cellulose ethers are especially alkalicarboxymethyl cellulose, methylcellulose, ethylcellulose, hydroxyethylcellulose and the so-called cellulose mixed-ethers, such as methylhydroxyethylcellulose and methylhydroxypropyl cellulose, as well as mixtures thereof. Especially suitable mixtures are sodium-carboxymethyl cellulose and methylcellulose, where the carboxymethylcellulose normally has a degree of substitution of 0.5 to 0.8 carboxymethyl groups per anhydro-glucose unit and the methylcellulose has a degree of substitution of 1.2 to 2 methyl groups per anhydroglucose unit. The mixtures preferably contain alkali metal carboxymethyl cellulose and non-ionic cellulose ethers in weight ratios of 80:20 to 40:60, especially from 75:25 to 50:50. Native starch is also suitable as a carrier, which is made up of amylose and amylopectin. Native starch is starch, which is obtained from natural sources, for instance from rice, potatoes, maize and wheat. Native starch is a commercial product and hence easily available. One or more of the materials mentioned above can be used as carrier substances, especially selected from the group of alkali metal carbonates, alkali metal sulfates, alkali metal phosphates, zeolites, water-soluble layered silicates, alkali metal silicates, polycarboxylates, cellulose ethers, polyacrylate/polymethacrylate and starch. Especially suitable are mixtures of alkali metal carbonates, especially sodium carbonate, alkali metal silicates, especially sodium silicate, alkali metal sulfates, especially sodium sulfate and zeolites.

Disintegration Agents

Furthermore, the solid preparations can also contain disintegration agents. These are the substances, which are added to the molded articles, in order to accelerate their degradation when brought in contact with water. These substances expand their volume when contacted with water, where on one hand the residual volume can be expanded (swelling), on the other hand also a pressure can be exerted through the release of gases, which lets the tablet disintegrate into smaller particles. Well-known disintegration agents are, for instance, the carbonate/citric acid systems, where other organic acids can also be used. Swelling disintegration agents are, for instance, synthetic polymers such as cross-linked polyvinyl pyrrolidone (PVP) or natural polymers or modified natural substances such as cellulose and starch and their derivatives, alginate or casein derivatives. As preferred disintegration agents within the scope of the present invention, the disintegration agents based on cellulose are used. Pure cellulose has the empirical formula (C₆H₁₀O₅)ₙ and formally represents a β-1,4-polyacetal of cellobiose, which, in turn, is made up of two molecules of glucose. Here suitable celluloses consist of around 500 to 5000 glucose units and thus have average molecular masses of 50,000 to 500,000. As disintegration agents based on cellulose within the scope of the present invention cellulose derivatives can also be used, which can be obtained from cellulose from polymer-analogous reactions. Such chemically modified celluloses include, for instance, products of esterification or etherification, in which hydroxyl hydrogen atoms are substituted. Also the celluloses, in which the hydroxyl groups are replaced by functional groups, which are not bonded through an oxygen atom, can be used as cellulose derivatives. The group of cellulose derivatives, for instance, includes, alkali metal celluloses, carboxymethylcellulose (CMC), cellulose ester and -ether as well as amino celluloses. The mentioned cellulose derivatives are preferably not used individually as disintegration agents based on cellulose, but instead in a mixture with cellulose. The content of cellulose derivatives in these mixtures is preferably below 50 wt.-%, especially preferred below 20 wt.-% with reference to the disintegration agent based on cellulose. Especially preferred as disintegration agents based on cellulose, pure cellulose is used, which is free from cellulose derivatives. As further disintegration agents based on cellulose or as part of these components, microcrystalline cellulose can be used. This microcrystalline cellulose is obtained through partial hydrolysis of cellulose under such conditions, which attack only the amorphous areas (about 30% of the total cellulose mass) of the cellulose and dissolve completely, but leave the crystalline areas (around 70%) undamaged. A subsequent disaggregation of the microfine cellulose arising through the hydrolysis produces the microcrystalline cellulose, which has a primary particle size of around 5 μm and can be compacted to form granulates with an average particle size of 200 μm. The disintegration agents can be, macroscopically observed, present in a homogeneously distributed form in the moulds, but microscopically form zones of high concentrations. Disintegration agents that can be used in the sense of the invention are, for instance, colloids, alginic acid and its alkali salts, amorphous or also partly crystalline layered silicates (bentonite), polyacrylate, polyethylene glycols. The preparations can contain the disintegration agents in quantities of 0.1 to 25, preferably 1 to 20 and especially 5 to 15 wt.-% with reference to the moulds.

Aromatic Substances

As perfume oils or fragrances, specific fragrant substances e.g. the synthetic products of the esters, ethers, aldehydes, ketones, alcohols and hydrocarbons types can be used. Fragrant substances of the ester type include e.g. benzyl acetate, phenoxymethyl isobutyrate, p-tertiary-butylcyclohexyl acetate, linalyl acetate, dimethylbenzylcarbinyl acetate, phenylethyl acetate, linalyl benzoate, benzyl formiate, ethylmethylphenyl glycinate, allylcyclohexyl propionate, styrallyl propionate and benzyl salicylate. The ethers include, for instance, benzylethyl ether, the aldehydes include the linear alkanals with 8-18 C atoms, citral, citronellal, citronellyloxyacetaldehyde, cyclamen aldehyde, hydroxy citronellal, lilial and bourgeonal, the ketones include e.g. the ionones, α-isomethylionons and methylcedryl ketone, the alcohols include anethol, citronellol, eugenol, geraniol, linalool, phenylethyl alcohol and terpinol, the hydrocarbons include mainly the terpenes such as limonenes and pinenes. Preferably used are the mixtures of different fragrant substances, which together generate a fragrance. Such perfume oils can also contain natural mixtures of fragrant substances, in the way these are obtained from plant sources e.g. pine, citrus, jasmine, patchouli, rose or Ylang-Ylang oils. Also suitable are clary, sage oil, camomile oil, clove oil, melissa oil, mint oil, oil of cinnamon leaves, linden blossom oil, juniper berry oil, vetiver oil, olibanum oil, galbanum oil and labdanum oil as well as orange oil, neroli oil, orange peel oil and sandalwood oil. The fragrant substances can be directly added to the medium as per the invention, but it can also be useful to place the fragrant substance on carriers, which reinforce the bonding of the perfumes with the clothes and cause the textile to release the fragrance slowly over a long period of time. Cyclodextrins have been used with good results as such carriers, where the cyclodextrin perfume complex can be coated with other auxiliary substances.

Inorganic Salts

Further suitable contents of the medium are water-soluble inorganic salts such as bicarbonates, carbonates, amorphous silicates, normal water glasses, which do not show any extraordinary builder properties, or mixtures thereof; especially used are alkali carbonates and/or amorphous alkali silicates, mainly sodium silicate with a molar ratio of Na₂O:SiO₂ from 1:1 to 1:4.5, preferably from 1:2 to 1:3.5. The content of sodium carbonate in the final preparations is preferably up to 40 wt.-%, especially preferred between 2 and 23 wt.-%. The content of sodium silicate in the medium (without special builder properties) is generally up to 10 wt.-% and preferably between 1 and 8 wt.-%. Further, as filler or diluent, sodium sulfate can be present in the medium in quantities ranging from 0 to 10, especially between 1 and 5 wt.-% with respect to the medium.

Preparation of the Medium

The detergent obtained by adding suitable auxiliary substances as per the invention can be produced or used as a watery solution or in the form of powder, extrudate, granulate or agglomerate. It can thereby be an al-purpose or also fine or coloured detergent and can be in compact or super-compact form or as tablets. Suitable methods, known from the prior art are appropriate for preparing such a medium. The medium is preferably manufactured by the process, in which particle-shaped components, which contain the contents of the detergent, are mixed with one another. The particle-shaped components can be prepared through spray drying, simple mixing or complex granulation methods, for instance, fluidisation granulation. Especially preferred is that at least one surfactant-containing component is prepared by fluidisation granulation. Furthermore, it can be especially preferred when watery preparations of alkali silicates and of alkali carbonates can be sprayed together with other contents of the detergent in a drying device, whereby a granulation can take place simultaneously along with the drying.

### EXAMPLES

### Example H1

### Preparation of disodium PEG-4-cocoyl MEA sulfosuccinate

In a 1 litre three-necked flask with stirrer, inner thermometer and reflux cooler, 301.7 g (1 mole) of an addition product of average 4 mole ethylene oxide to C₁₂-C₁₄ coco fatty acid monoethanol amide were placed and heated to 80° C. Within 30 minutes a total of 117.7 g (1.2 mole) of maleic acid anhydride were added under stirring at such a speed, that the temperature did not rise above 90° C. After the addition was complete, the mixture was stirred at 80° C. for 5 hours. 350 g (1 mole) of the succinic acid prepared in the first stage was added to a solution of 125.2 g (1 mole) sodium sulfite and 712.8 g of water at 25° C. The mixture was heated to 75° C. and stirred for 2 hours at this temperature. The resulting sulfosuccinate was obtained as a light-yellow clear solution with characteristics as given in table 1:

TABLE 1
Characteristics

| Composition | Content [wt.-%] |
|---|---|
| Anionic-surfactant content as per Epton | 4.2 |
| Sodium sulfate | 0.4 |
| Sodium sulfite | 0.5 |
| Sulfosuccinic acid | 1.2 |
| Water | 59.6 |

### Examples 1 to 5, Comparison Examples V1 to V4

### Determination of the Foaming Power

The foaming power of the different sulfosuccinates was determined in the rotor foam test (0.5 g/l, 15° dH, 40° C., pH 6, 1300 rpm). The results are given in table 2. The examples 1 to 3 are of the invention, the examples V1 and V2 are the comparison examples.

TABLE 2
Foaming power of sulfosuccinates

| | | Foam depth [ml] after | | | | |
|---|---|---|---|---|---|---|
| Exam. | Sulfosuccinate | 0 min | 30 min | 1 h | 1.5 h | 3 h |
| 1 | Disodium PEG-2 | 0 | 221 | 342 | 453 | 782 |
| | cocoyl MEA | | | | | |
| | sulfosuccinate | | | | | |
| 2 | Disodium PEG-4 | 0 | 305 | 575 | 887 | 871 |
| | cocoyl MEA | | | | | |
| | sulfosuccinate ¹⁾ | | | | | |
| 3 | Disodium PEG-6 | 0 | 204 | 306 | 419 | 754 |
| | cocoyl MEA | | | | | |
| | sulfosuccinate | | | | | |
| V1 | Disodium PEG-6 | 0 | 196 | 286 | 350 | 498 |
| | oleamido MEA | | | | | |
| | sulfosuccinate ²⁾ | | | | | |
| V2 | Disodium PEG-4 | 0 | 200 | 302 | 403 | 668 |
| | cocoyl MIPA | | | | | |
| | sulfosuccinate ³⁾ | | | | | |

¹⁾ Plantapon ® CSB (Cognis)
²⁾ Standapol ® SH 100
³⁾ Rewopol ® SBZ

The results show that the sulfosuccinates of the invention are clearly superior to the ones available in the market in their foaming behavior.

In the same way, the foaming power of the surfactant mixtures was determined. The results are summarised in table 3. The examples 4 and 5 are of the invention, the examples V3 and V4 are comparison examples.

TABLE 3
Foaming power of surfactant mixture

| | | Foam depth [ml] after | | | | |
|---|---|---|---|---|---|---|
| Exam. | Sulfosuccinate | 0 min | 30 min | 1 h | 1.5 h | 3 h |
| V3 | Cocamido | 0 | 218 | 298 | 379 | 520 |
| | propylbetaine ⁴⁾ | | | | | |
| V4 | Cocoglucosides ⁵⁾ | 0 | 201 | 314 | 422 | 555 |
| 4 | Disodium PEG-6 cocoyl | 0 | 345 | 622 | 952 | 912 |
| | MEA sulfosuccinate | | | | | |
| | Cocamidopropylbetaine | | | | | |
| | (50:50) | | | | | |
| 5 | Disodium PEG-6 cocoyl | 0 | 351 | 625 | 936 | 901 |
| | MEA sulfosuccinate | | | | | |
| | Cocoglucosides (50:50) | | | | | |

⁴⁾ Dehypon ® PK 45 (Cognis)
⁵⁾ Plantacare ® APG 1200 (Cognis)

The result show that the equal-weight mixtures of the sulfosuccinates of the invention with alkylamidobetaines or alkyloligoglucosides show an unexpected synergy in foaming behavior.

1-14. (canceled)

15. A sulfosuccinate of the formula, 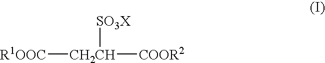
in which R¹ represents an R³CONR⁴(CH₂)ₙ(OCH₂CH₂)ₘ— group, R² is hydrogen, an alkali metal, ammonium, alkyl ammonium or R¹, R³CO is a linear, saturated acyl group with 12 to 18 carbon atoms, R⁴ is hydrogen or methyl, n is a number of 2 to 4, m is a number of 2 to 10 and X is an alkali metal, ammonium or alkyl ammonium.

16. The sulfosuccinate of claim 15, wherein, R is an alkali metal.

17. The sulfosuccinate of claim 15, wherein, R³CO is a linear, saturated acyl group with 12 to 14 carbon atoms.

18. The sulfosuccinate of claim 15, wherein, R⁴ is hydrogen.

19. The sulfosuccinate of claim 15, wherein, n is 2 or 3.

20. The sulfosuccinate of claim 15, wherein, m is a number of 3 to 5.

21. The sulfosuccinate of claim 15, wherein, R² is an alkali metal, R³CO is a linear, saturated acyl group with 12 to 14 carbon atoms, R⁴ is hydrogen, n is 2 or 3, m is 3 to 5 and X is an alkali metal.

22. A method for preparing the sulfosuccinates of claim 15, comprising:
a) condensing a saturated fatty acid with 12 to 18 carbon atoms with a linear C₂-C₄ alkanolamine to form a fatty acid alkanolamide;
b) reacting 1 to 10 mole of ethylene oxide with the fatty acid alkanolamide to form a fatty acid alkanolamide polyglycolether;
c) reacting the fatty-acid alkanolamide polyglycolether with maleic acid anhydride (MSA) to form a maleic acid ester; and
d) reacting hydrogen sulfite with the succinic acid ester to form the sulfosuccinate.

23. The method of claim 22, wherein, the fatty acid alkanolamide polyglycolether and the MSA are mixed in a molar ratio of 1:1 to 1:1.5.

24. The method of claim 22, wherein, the reaction of the fatty acid alkanolamide polyglycolether and the MSA is conducted at a temperature in a range of 60° C. to 90° C. in the absence of solvents.

25. Cosmetic and pharmaceutical compositions comprising the sulfosuccinate of claim 15.

26. Detergents, dishwashing liquids, and cleaning agents comprising the sulfosuccinate of claim 15.

27. A surfactant composition comprising:
a) the sulfosuccinate of claim 15; and
b) at least one of an alkylamidobetaine and an alkyl oligoglucoside.

28. The surfactant mixture of claim 27, wherein, said surfactant composition contains the components (a) and (b) in a weight ratio of 90:10 to 10:90.
